(19) United States
(12) Patent Application Publication
(10) Pub. No.: US 2023/0337304 A1
(43) Pub. Date: Oct. 19, 2023

(54) Resuming multi-radio dual connectivity

(71) Applicant: GOOGLE LLC, Mountain View, CA (US)

(72) Inventor: Chih-Hsiang Wu, Taoyuan City (TW)

(21) Appl. No.: 17/924,828

(22) PCT Filed: May 10, 2021
(86) PCT No.: PCT/US2021/031485

§ 371 Date: Nov. 11, 2022

Related U.S. Application Data
(60) Provisional application No. 63/024,675, filed on May 14, 2020.

(51) Int. Cl. H04W 76/15; H04W 76/19; H04W 52/36

(52) U.S. Cl. CPC H04W 76/15; H04W 76/19; H04W 52/367

(57) ABSTRACT

A node of a radio access network (RAN) can implement a method for facilitating resumption of dual connectivity for a user equipment (UE). The method includes receiving, from the UE, a request to resume radio connectivity with the UE, and determining whether to resume dual connectivity with the UE. The method also includes generating a message to instruct the UE to resume radio connectivity with the node, where the generating includes, based on the determining, either including in the message or excluding from the message an indication of a maximum power limit for UE uplink transmissions. The method further includes transmitting the message to the UE

### TECHNICAL FIELD

This disclosure relates generally to wireless communications and, more particularly, to resuming multi-radio dual connectivity (MR-DC) during an RRC resume procedure in which a user equipment (UE) resumes suspended radio connections with a master node (MN) and a secondary node (SN), respectively.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A user device (or user equipment, commonly denoted by the acronym “UE”) in some cases can concurrently utilize resources of multiple network nodes, e.g., base stations, interconnected by a backhaul. When these network nodes support the same radio access technology (RAT) or different RATs, this type of connectivity is referred to as Dual Connectivity (DC) or Multi-Radio DC (MR-DC), respectively. Typically, when a UE operates in DC or MR-DC, one base station operates as a master node (MN), and the other base station operates as a secondary node (SN). The backhaul can support an Xn interface, for example.

The MN can provide a control-plane connection and a user-plane connection to a core network (CN), whereas the SN generally provides only a user-plane connection. The cells associated with the MN define a master cell group (MCG), and the cells associated with the SN define a secondary cell group (SCG). The UE and the base stations MN and SN can use signaling radio bearers (SRBs) to exchange radio resource control (RRC) messages, as well as non-access stratum (NAS) messages.

There are several types of SRBs that a UE can use when operating in DC. SRB1 and SRB2 resources allow the UE and the MN to exchange RRC messages related to the MN and to embed RRC messages related to the SN, and can be referred to as MCG SRBs. SRB3 resources allow the UE and the SN to exchange RRC messages related to the SN, and can be referred to as an SCG SRB. Split SRBs allow the UE to exchange RRC messages directly with the MN by using radio resources of the MN, the SN, or both the MN and SN. Further, the UE and the base stations (e.g., MN and SN) use data radio bearers (DRBs) to transport data on a user plane. DRBs terminated at the MN and using the lower-layer resources of only the MN can be referred to as MCG DRBs, DRBs terminated at the SN and using the lower-layer resources of only the SN can be referred to as SCG DRBs, and DRBs terminated at the MCG but using the lower-layer resources of both the MN and the SN can be referred to as split DRBs.

A base station (e.g., MN, SN) and/or the CN in some cases causes the UE to transition from one operational state of the Radio Resource Control (RRC) protocol to another state as specified in 3GPP Technical Specifications 36.331 v16.0.0 and 38.331 v16.0.0. More particularly, the UE can operate in an idle state (e.g., EUTRA-RRC_IDLE or NR-RRC IDLE), in which the UE does not have a radio connection with a base station; a connected state (e.g., EUTRA-RRC_CONNECTED or NR-RRC CONNECTED), in which the UE has a radio connection with the base station; or an inactive state (e.g., EUTRA-RRC_IDLE, NR-RRC IDLE, EUTRA-RRC INACTIVE, or NR-RRC INACTIVE), in which the UE has a suspended radio connection with the base station.

In some scenarios, a UE in MR-DC with an MN and an SN can operate in the connected state and subsequently transition to the inactive state. In the inactive state, the radio connections between the UE and the MN and SN are suspended, i.e., the MR-DC is suspended between the UE and the MN and SN. While the radio connection between the UE and MN is suspended, the UE and MN retain configurations that the UE and MN use to communicate with each other before the transition. Similarly, while the radio connection between the UE and the SN is suspended, the UE and SN retain configurations that the UE and the SN use to communicate with each other before the transition. In response to a network-triggering event (e.g., RAN paging), such as when the MN pages the UE (e.g., for an incoming phone call), or when the UE is otherwise triggered to send data (e.g., outgoing phone call, browser launch, non-access-stratum messages, or location service), the UE can then transition back to the connected state. To carry out the transition, the UE can request the MN to resume the suspended radio connection(s) (e.g., by sending an RRC resume request message), so that the MN can configure the UE to again operate in the connected state.

More specifically, the MN can resume MR-DC by resuming the suspended connections between the UE and the MN and between the UE and the SN, respectively (e.g., by sending an RRC resume message to the UE). In some scenarios, the UE can reuse retained configurations to communicate with the MN and the SN after resuming the suspended connections. By resuming MR-DC upon transitioning to the connected state from the inactive state, the UE can immediately take advantage of the high data rate and low latency available during MR-DC.

However, a UE can encounter various problems when attempting to resume MR-DC after transitioning from an inactive state. As a first example, some UEs may not be capable of applying retained configurations to communicate with the SN upon transitioning to the connected state. More specifically, a UE may not be capable of retaining the SN configurations long enough to resume MR-DC using the SN configurations. As a result, the MN may only configure the UE to resume single connectivity when the UE transitions from the inactive state to the connected state. The MN may configure the UE to operate in MR-DC at a later time, but this delays MR-DC operation, and therefore delays the availability of the higher data rate that MR-DC offers.

As another example, a UE may not be aware of limitations on power and timing of uplink transmissions to the RAN after resuming MR-DC. The MN can configure a UE to resume MR-DC using an RRC connection resume procedure, which causes the UE to transition from an inactive state to a connected state. At a later time, in accordance with current standards (e.g., 3GPP TS 36.331 v16.0.0), an MN can inform a UE operating in MR-DC of maximum power limits on uplink transmissions to the MN or SN, or timing instances in which the UE is allowed to transmit to the MN or SN (e.g., by transmitting an RRCConnectionReconfiguration message to the UE including parameters such as p-MaxEUTRA, p-MaxUE-FR1, tdm-PattemConfig-r15 and/or tdm-PatternConfig-r16). However, during the period between when the UE transitions to a connected state and when the UE receives these parameters, the UE may not be aware of these power and timing limits, which either requires the UE to refrain from transmitting signals or results in other network inefficiencies (e.g., overuse of uplink resources by the UE).

As yet another example, if the MN includes SN configurations in RRC resume messages sent to UEs, certain UEs may not be able to comply with at least a portion of the SN configuration. In such a scenario, the UE may not be aware of how to communicate with the RAN, and may attempt to communicate with the RAN in a way that differs from the SN configuration. Correspondingly, the RAN may not be aware of the status of the UE, and may not be capable of properly processing and/or responding to unexpected transmissions from the UE.

### SUMMARY

Various types of RAN nodes of this disclosure implement techniques to configure a UE to resume MR-DC after transitioning from an inactive to a connected RRC state, with less delay than prior art techniques and/or with other advantages relative to prior art techniques (e.g., avoiding unknown UE states). Generally speaking, in some implementations, an MN can cause an SN to release or suspend lower layers (e.g., PHY, MAC, and/or RLC layers) for communicating with the UE in response to determining to configure the UE to enter an inactive state. After receiving a request from the UE to resume radio connectivity, the MN can send an indication to the SN to re-establish or resume lower layers for communicating with the UE. In response, the SN provides a new configuration the UE can use to communicate with the SN. The SN can provide a full configuration if the RAN (MN or SN) determines that the UE releases the old SN configuration before resuming radio connectivity, or provide a delta configuration if the RAN determines that the UE can retain and apply the old SN configuration when resuming radio connectivity. If the SN includes a central unit (CU) and a distributed unit (DU) of a base station, then the CU can communicate with the DU to receive a full or a delta configuration for the DU, and can provide this DU configuration to the MN.

In some implementations, a single base station serves as both the MN and the SN, with the MN including a CU and a first DU of the base station, and the SN including the CU and a second DU of the base station. Similar to the techniques described above, the CU can cause the second DU to provide a new configuration that the UE can use to communicate with the second DU (and thus, communicate with the SN) when resuming MR-DC.

The MN can include the new full or delta configuration in an RRC resume message that the MN sends to the UE, so that the UE can immediately utilize the configuration to communicate in MR-DC with both the MN and the SN.

A UE of this disclosure can also implement techniques for resuming MR-DC after transitioning from an inactive to a connected RRC state. For example, if the UE communicates in MR-DC prior to transitioning to the inactive state, the UE can retain parameters specifying power and/or timing requirements for communicating in MR-DC. The UE can re-use these parameters to communicate in MR-DC after transitioning back to the connected state. Accordingly, the UE can avoid over-use of network resources (e.g., causing excessive interference to other UEs by transmitting uplink signals at high power).

As another example, if the UE receives an RRC resume message including an SN and an MN configuration with which the UE is unable to fully comply, then the UE can transition to an idle state without a suspended radio connection. Conversely, if the UE can fully comply with the MN configuration but not the SN configuration, the UE can transmit an SCG failure information message to the MN. In this way, the UE can react to its failure to comply with an MN and/or SN configuration in manner that is understood and expected by the RAN.

An example embodiment of the techniques of this disclosure is a method, in a first node of a RAN, of facilitating resumption of dual connectivity for a UE. The method includes transmitting, to a second node of the RAN communicating with the UE in accordance with a first configuration, a first message that causes the second node to release or suspend lower layers for communicating with the UE. The method also includes transmitting, to the second node after transmitting the first message, a second message that causes the second node to re-establish or resume the lower layers for communicating with the UE. The method further includes receiving, from the second node in response to the second message, a second configuration the UE is to use to communicate with the second node.

Another example embodiment of these techniques is a method, in a first node of a RAN, of facilitating resumption of dual connectivity for a UE, where the first node previously communicated with the UE in accordance with a first configuration. The method includes receiving a first message from a second node of the RAN and releasing or suspending, by processing hardware of the first node, lower layers for communicating with the UE in response to the first message. The method also includes receiving a second message from the second node and, in response to the second message: re-establishing or resuming, by the processing hardware, the lower layers for communicating with the UE, and transmitting, to the second node, a second configuration the UE is to use to communicate with the first node.

Yet another example embodiment of these techniques is a network node including processing hardware and configured to execute the methods above.

Another example embodiment of these techniques is a method in a UE for resuming dual connectivity in a RAN. The method includes operating in dual connectivity with a master node via a first radio connection and a secondary node via a second radio connection, and receiving, from the master node, one or more configuration parameters for UE communications with one or both of the master node and the secondary node. The method also includes transitioning, by processing hardware of the UE, an operational state of the UE that is associated with a protocol for controlling radio resources from a connected state to an inactive state at least in part by suspending the first and second radio connections. The method further includes, while in the inactive state, retaining the one or more configuration parameters and receiving from the RAN a command to resume radio connectivity with the RAN. Still further, the method includes utilizing the retained one or more configuration parameters to communicate with the master node or the secondary node after resuming radio connectivity with the RAN.

Yet another example embodiment of these techniques is a method in a UE for resuming dual connectivity in a RAN. The method includes receiving, from the RAN, a command to resume suspended dual connectivity with the RAN, the command including at least one configuration the UE is to use to communicate with a master node or a secondary node. The method also includes determining, by processing hardware, that the UE is unable to comply with at least a portion of the at least one configuration, and, in response to the determining, transitioning to an idle state or transmitting a failure message to the master node.

A further example embodiment of these techniques is a UE including processing hardware and configured to execute the methods above.

### BRIEF DESCRIPTION OF THE DRAWINGS

FIG. 1A is a block diagram of an example system in which one or more base stations and/or a user equipment (UE) can implement the techniques of this disclosure for resuming suspended multi-RAT dual connectivity (MR-DC) between the UE and a radio access network (RAN);

FIG. 1B is a block diagram of an example base station including a central unit (CU) and a distributed unit (DU) that can operate in the system of FIG. 1A;

FIG. 2 is a block diagram of an example protocol stack according to which the UE of FIG. 1A can communicate with base stations;

FIGS. 3A-3E are example message sequences in which a master node (MN) causes a secondary node (SN) to provide an SN configuration for use by a UE when resuming MR-DC;

FIGS. 4A-4E are example message sequences similar to FIGS. 3A-3E, but where the SN includes both a central unit (CU) and a distributed unit (DU);

FIGS. 5A-5E are example message sequences similar to FIGS. 3A-3E, but where portions of a single base station serve as the MN and the SN;

FIG. 6 is a flow diagram of an example method for resuming MR-DC with a UE, which may be implemented by an MN;

FIG. 7 is a flow diagram of an example method for responding to an SN Modification Request message received from an MN, which may be implemented by an SN;

FIG. 8 is a flow diagram of an example method for facilitating resumption of MR-DC using a full or a delta SN configuration, which may be implemented by an MN;

FIG. 9 is a flow diagram of an example method for facilitating resumption of MR-DC using a full or delta SN configuration, which may be implemented by an SN;

FIG. 10 is a flow diagram of an example method of responding to an SN Modification Request message received from an MN and including an indication to release lower layers for a UE, which can be implemented by a CU of an SN;

FIG. 11 is a flow diagram of an example method of responding to an SN Modification Request message received from an MN and including an indication to suspend lower layers for a UE, which can be implemented by a CU of an SN;

FIG. 12 is a flow diagram of an example method of responding to an SN Modification Request message received from an MN and including an indication to re-establish lower layers for a UE, which can be implemented by a CU of an SN;

FIG. 13 is a flow diagram of an example method of responding to an SN Modification Request message received from an MN and including an indication to resume lower layers for a UE, which can be implemented by a CU of an SN;

FIG. 14 is a flow diagram of an example method for providing a DU configuration to a CU that a UE can use to resume MR-DC, which can be implemented by a DU of an SN;

FIG. 15 is a flow diagram of an example method for providing power and/or timing parameters a UE is to use after resuming MR-DC, which can be implemented by an MN;

FIG. 16 is a flow diagram of an example method for retaining power and/or timing parameters a UE can use after resuming MR-DC, which can be implemented by a UE;

FIG. 17 is a flow diagram of an example method a UE can perform in response to determining that the UE is unable to apply an SN configuration in an RRC resume message, which can be implemented by a UE;

FIG. 18 is a flow diagram of an example method a UE can perform in response to determining that the UE is unable to apply an MN or an SN configuration in an RRC resume message, which can be implemented by a UE;

FIG. 19 is a flow diagram of an example method for resuming MR-DC, which can be implemented by a network node of this disclosure;

FIG. 20 is a flow diagram of another example method for resuming MR-DC, which can be implemented by a network node of this disclosure;

FIG. 21 is a flow diagram of an example method for resuming MR-DC, which can be implemented by a UE of this disclosure; and

FIG. 22 is a flow diagram of another example method for resuming MR-DC, which can be implemented by a UE of this disclosure.

### DETAILED DESCRIPTION OF THE DRAWINGS

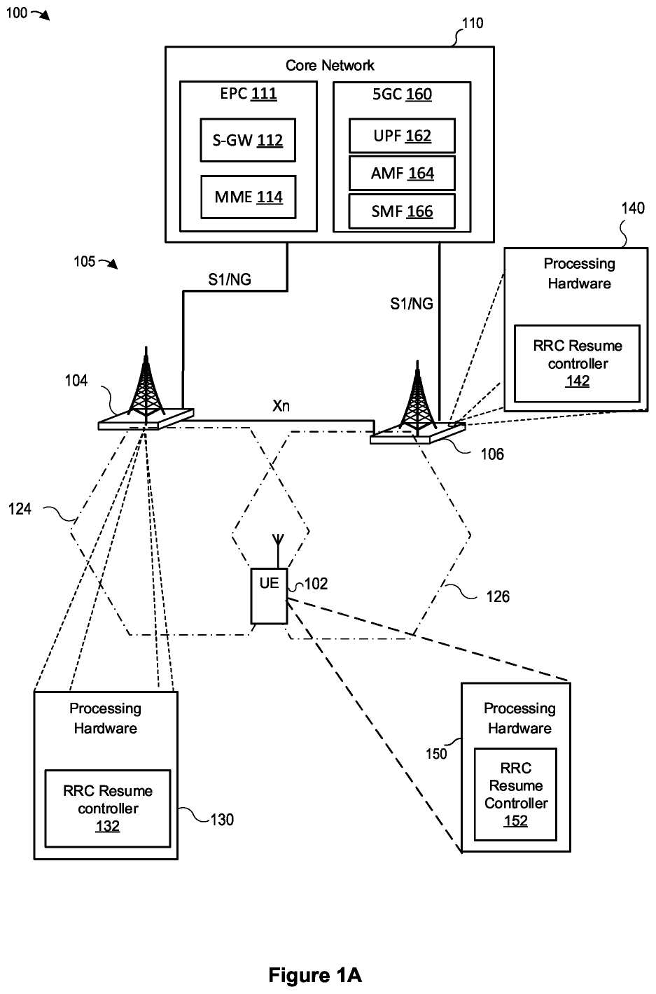

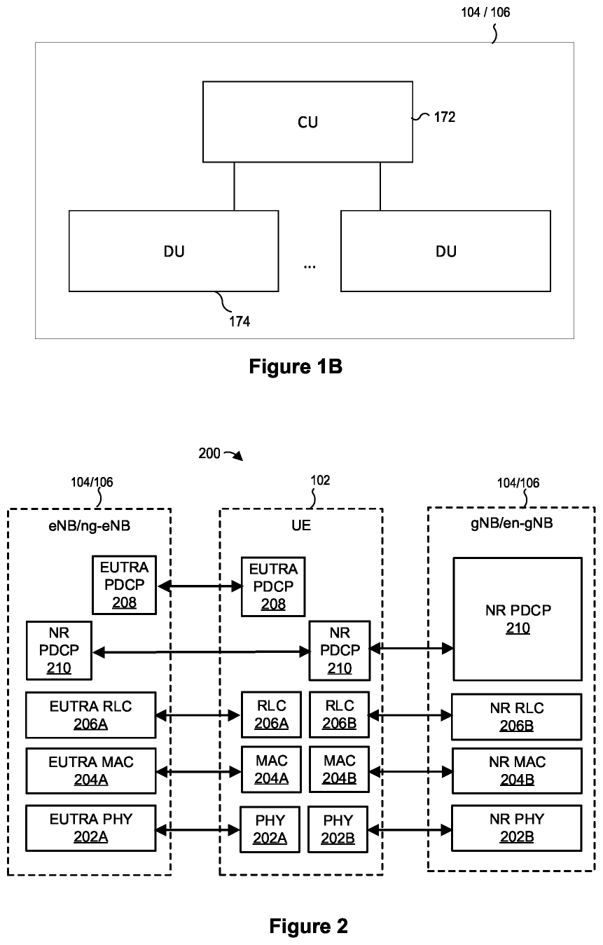

As discussed in detail below, network nodes of a radio access network (RAN) in communication with a UE can implement the techniques disclosed herein to manage multi-radio dual connectivity (MR-DC) in scenarios involving distributed base station architectures and scenarios involving suspending and resuming dual connectivity, for example. Prior to discussing these techniques, example communication systems which can implement these techniques are considered with reference to FIGS. 1A-1B.

FIG. 1A depicts an example wireless communication system 100 that includes a UE 102, a base station (BS) 104, a base station 106, and a core network (CN) 110. The base stations 104 and 106 can operate in a RAN 105 connected to the same core network (CN) 110. The CN 110 can be implemented as an evolved packet core (EPC) 111 or a fifth generation (5G) core (5GC) 160, for example.

Among other components, the EPC 111 can include a Serving Gateway (S-GW) 112 and a Mobility Management Entity (MME) 114. The S-GW 112 in general is configured to transfer user-plane packets related to audio calls, video calls, Internet traffic, etc., and the MME 114 is configured to manage authentication, registration, paging, and other related functions. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can communicate in DC with the base station 104 and the base station 106 operating as a master node (MN) and a secondary node (SN), respectively. To directly exchange messages during DC scenarios and other scenarios discussed below, the base station 104 (also referred to herein as MN 104) and the base station 106 (also referred to herein as SN 106) can support an X2 or Xn interface. In general, the CN 110 can connect to any suitable number of base stations supporting 5G new radio (NR) cells and/or EUTRA cells.

The base station 104 is equipped with processing hardware 130 that can include one or more general-purpose processors such as CPUs and non-transitory computer-readable memory storing machine-readable instructions executable on the one or more general-purpose processors, and/or special-purpose processing units (e.g., an application-specific integrated circuit (ASIC) or a digital signal processor (DSP)). The processing hardware 130 in an example implementation includes an RRC resume controller 132 configured to resume a radio connection between the UE 102 and the RAN 105 with a new DC configuration and/or release a previous DC configuration.

The SN 106 is equipped with processing hardware 140 that can also include one or more general-purpose processors such as CPUs and non-transitory computer-readable memory storing machine-readable instructions executable on the one or more general-purpose processors, and/or special-purpose processing units (e.g., an ASIC or a DSP). The processing hardware 140 in an example implementation includes an RRC resume controller 142 configured to process an SN modification procedure in response to an RRC resume request from the UE 102. In general, because a base station can operate as an MN or an SN in different scenarios, the RRC resume controllers 132 and 142 can implement similar sets of functions and each support both MN and SN operations.

Still referring to FIG. 1A, the UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC resume controller 152 configured to resume radio connection(s) with the RAN 105 (e.g., the MN 104 and/or the SN 106).

More particularly, the RRC resume controllers 132, 142, and 152 can implement at least some of the techniques discussed below (with reference to various messaging and flow diagrams) to manage RRC configurations.

In operation, the UE 102 can use a radio bearer (e.g., a DRB or an SRB) that at different times terminates at the MN 104 or the SN 106. The UE 102 can receive a radio bearer configuration configuring the radio bearer from the MN 104 or the SN 106. The UE 102 can apply one or more security keys when communicating on the radio bearer, in the uplink (from the UE 102 to a base station) and/or downlink (from a base station to the UE 102) direction. The UE 102 in some cases can use different RATs to communicate with the base stations 104 and 106. Although the examples below may refer to specific RAT types, 5G NR or EUTRA, in general the techniques of this disclosure also can apply to other suitable radio access and/or core network technologies.

FIG. 1B depicts an example distributed implementation of a base station such as the base station 104 or 106. The base station in this implementation can include a centralized unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an RRC resume controller 142 configured to manage or control one or more RRC configurations and/or RRC procedures when the base station 106 operates as an SN. The DU 174 is also equipped with processing hardware that can include one or more general-purpose processors such as CPUs and non-transitory computer-readable memory storing machine-readable instructions executable on the one or more general-purpose processors, and/or special-purpose processing units. In some implementations and/or scenarios, the processing hardware 130 and/or 140 may be distributed among the CU 172 and the DU 174 (or one or more DUs 174). In some examples, the processing hardware in an example implementation includes a medium access control (MAC) controller configured to manage or control one or more MAC operations or procedures (e.g., a random access procedure) and a radio link control (RLC) controller configured to manage or control one or more RLC operations or procedures when the base station 106 operates as an MN, an SN. The processing hardware may include further a physical layer controller configured to manage or control one or more physical layer (PHY) operations or procedures.

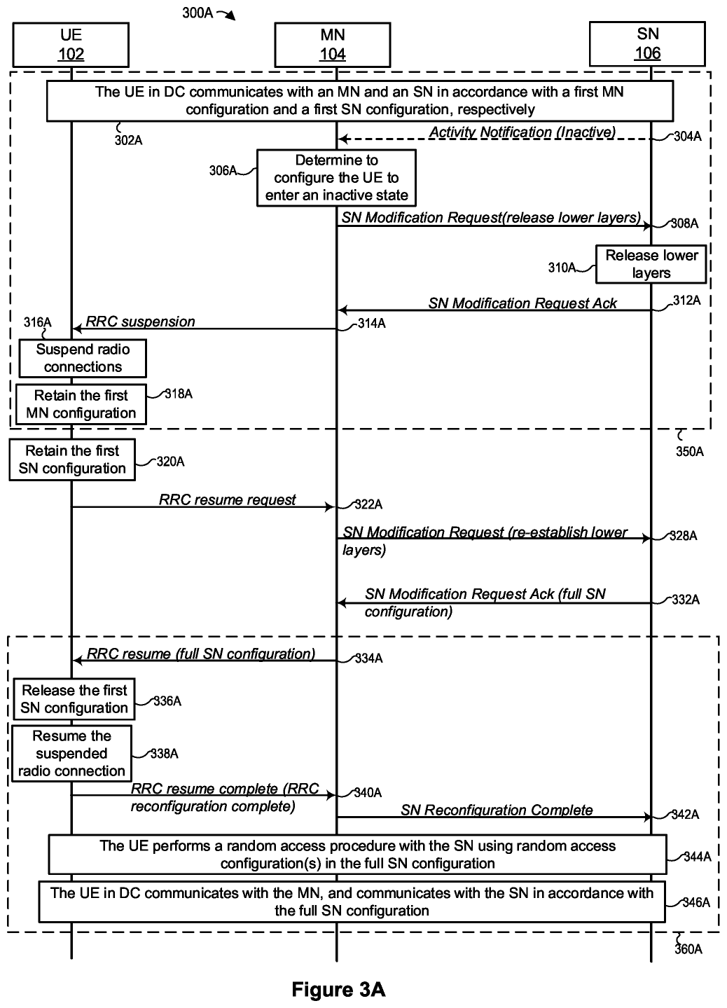

FIG. 2 illustrates, in a simplified manner, an example radio protocol stack 200 according to which the UE 102 may communicate with an eNB/ng-eNB or a gNB (e.g., one or more of the base stations 104 or 106). In the example stack 200, a PHY 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA packet data convergence protocol (PDCP) sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP sublayer 210 over the EUTRA RLC sublayer 206A.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide SRBs to exchange RRC messages, for example. On a user plane, the EUTRA PDCP sublayer 208 and the NR PDCP sublayer 210 can provide DRBs to support data exchange.

In scenarios where the UE 102 operates in EUTRA/NR DC (EN-DC) or NG-RAN EN-DC (NGEN-DC), with the base station 104 operating as an MeNB or Mng-eNB, and the base station 106 operating as an SgNB, the wireless communication system 100 can provide the UE 102 with an MN-terminated bearer that uses the EUTRA PDCP sublayer 208, or an MN-terminated bearer that uses the NR PDCP sublayer 210. The wireless communication system 100 in various scenarios can also provide the UE 102 with an SN-terminated bearer, which uses only the NR PDCP sublayer 210. The MN-terminated bearer can be an MCG bearer, a SCG bearer, or a split bearer. The SN-terminated bearer can be, an MCG bearer, an SCG bearer or a split bearer. The MN-terminated bearer can be an SRB (e.g., SRB1 or SRB2) or a DRB. The SN-terminated bearer can an SRB or a DRB.

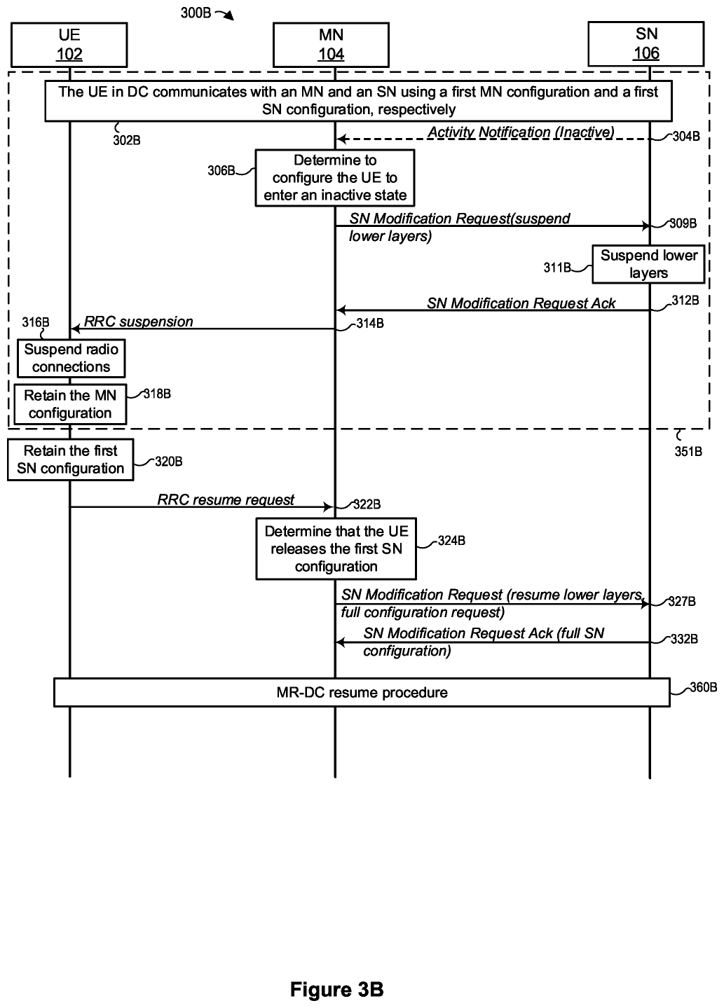

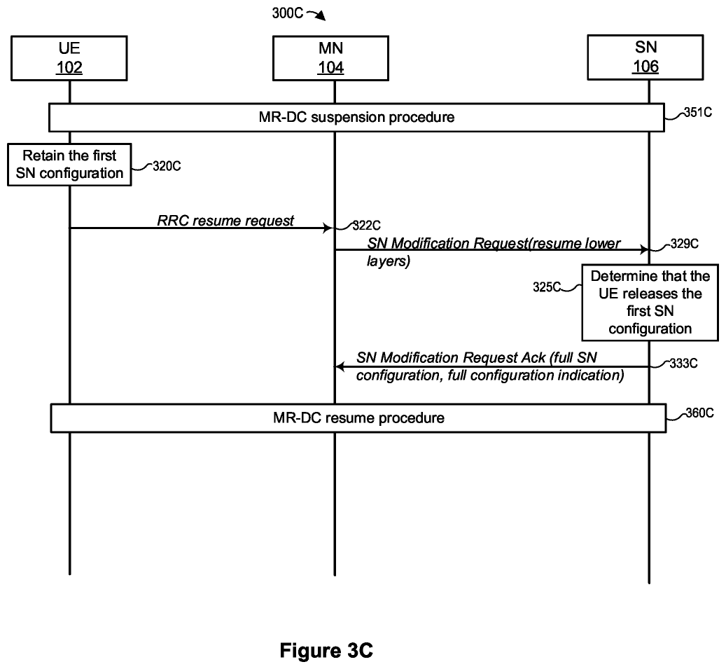

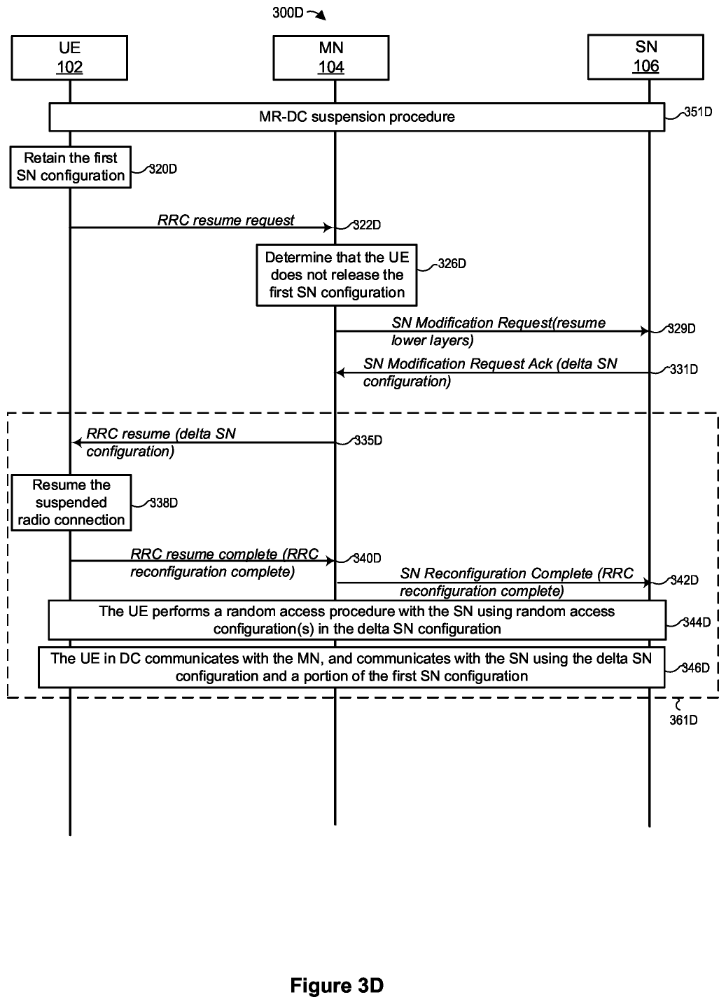

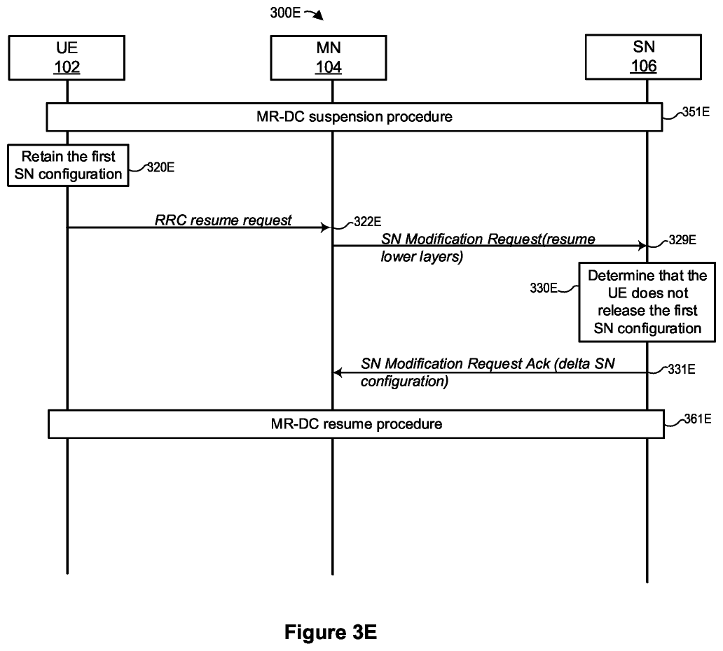

Next, several example scenarios in which the base stations operating in the system of FIG. 1A resume radio connections (i.e., MR-DC) between the UE 102 and the RAN 105 are discussed with reference to FIGS. 3A-5E. Generally speaking, events in FIGS. 3A-5E that are similar are labeled with similar reference numbers (e.g., event 322A is similar to events 322B-E, 422A-E, and 522A-E), with differences discussed below where appropriate.

Referring first to FIG. 3A, in a scenario 300A, the base station 104 operates as an MN, and the base station 106 operates as an SN. Initially, the UE 102 in DC communicates 302A uplink (UL) PDUs and/or downlink (DL) PDUs with the MN 104 and SN 106 in accordance with a first MN configuration and a first SN configuration, respectively. In some implementations, the UE 102 in DC can communicate 302A UL PDUs and/or DL PDUs via radio bearers which can include SRBs and/or DRBs. The MN 104 and/or the SN 106 can configure the radio bearers to the UE 102.

At a later time, the MN 104 can determine that data inactivity exists for the UE 102 and, in response, determine 306A to configure the UE 102 to enter an inactive state. In some implementations, the MN 104 determines that data inactivity exists for the UE 102 based on a message that the MN 104 receives from the SN 106. For example, the SN 106 may detect data inactivity for the UE 102, and in response send 304A an Activity Notification message with an inactive indication to the MN 104. The MN 104 can then determine that data inactivity exists for the UE 102 based on the received Activity Notification message. In other implementations, the MN 104 can start a data inactivity timer to monitor data activity. In some of these implementations, for example, if the data inactivity timer expires and the MN 104 did not transmit data to, or receive data from, the UE 102 while the data inactivity timer was running, then the MN 104 detects data inactivity for the UE 102. Conversely, if the MN 104 has data to be transmitted to the UE 102 or receives data from the UE 102 while the data inactivity timer is running, then the MN 104 can restart the data inactivity timer.

In some alternative implementations, the MN 104 can determine 306A to configure the UE 102 to enter an idle state with a suspended radio connection, rather than an inactive state.

In response to the determination 306A, the MN 104 sends 308A to the SN 106 an SN Modification Request message that includes an indication to release lower layers (e.g., PHY 202A/202B, MAC 204A/204B, and/or RLC 206A/206B) for the UE 102. In response to the SN Modification Request message, the SN 106 releases 310A the lower layers and sends 312A an SN Modification Request Acknowledge message to the MN 104. More specifically, in some implementations, the SN 106 can release lower layer resources that are allocated to communicate with the UE 102. These resources can include, for example, software, firmware, memories (e.g., memory hardware or storage space within memory hardware), and/or processing power that the SN 106 uses to implement functions of the PHY 202A/202B, MAC 204A/204B, and/or RLC 206A/206B layers for communicating with the UE 102. For example, the SN 106 can allocate processing power from an ASIC, DSP, and/or CPU of the SN 106 for communicating with the UE 102, and may release the allocated processing power in response to the indication to release lower layers. In other implementations, the SN 106 can release the first SN configuration in response to the indication to release lower layers. In some implementations, the SN 106 can retain at least one interface identifier (ID) of the UE 102 for exchanging interface messages between the MN 104 and the SN 106 in response to the indication to release lower layers. For example, if the interface between the MN 104 and the SN 106 is an Xn interface (e.g., the Xn interface shown in FIG. 1A), the at least one interface ID can include a first UE XnAP ID allocated by the SN 106, and a second UE XnAP ID allocated by the MN 104. In another example, if the interface between the MN 104 and the SN 106 is an X2 interface, the at least one interface ID can include a first UE X2AP ID allocated by the SN 106, and a second UE X2AP ID allocated by the MN 104.

In some implementations, the MN 104 stores a UE context for the UE 102 (e.g., the UE Access Stratum (AS) context or the UE Inactive AS Context as defined by the 3GPP specifications, a portion of the UE AS context, or a portion of the UE Inactive AS Context). The MN 104 communicates with the UE 102 according to the UE context while the UE 102 is in a connected state. The UE context can include a security key, a configuration for an MCG (e.g., including one or more cells of the MN 104), and radio bearer configuration(s) configuring one or more MN-terminated bearers and/or one or more SN-terminated bearers, for example. The one or more MN-terminated bearers and/or the one or more SN-terminated bearers can include SRB(s) and/or DRB(s).

In response to the determination 310A, after the MN 104 transmits 308A the SN Modification Request message or after the SN 106 transmits 312A the SN Modification Request Acknowledge message, the MN 104 transmits 314A an RRC suspension message to cause the UE 102 to suspend radio connections with the MN 104 and the SN 106. In response to the RRC suspension message, the UE 102 suspends 316A the radio connections but retains 318A the first MN configuration (or at least, retains 318A some configurations in the first MN configuration). After suspending 316A the radio connections, the UE 102 can transition to an inactive state or an idle state (e.g., an idle state with a suspended RRC connection). The RRC suspension message can include a SuspendConfig IE, an RRC-InactiveConfig-r15 IE, or a ResumeIdentity-r13 IE. The events 302A, 304A, 306A, 308A, 310A, 312A, 314A 316A, and 318A are collectively referred to in FIG. 3A as an MR-DC suspension procedure 350A.

With continued reference to FIG. 3A, upon receiving 314A the RRC suspension message, the UE 102 may retain 320A the first SN configuration (or retain 320A some configurations in the first SN configuration). As discussed below, however, the UE 102 in some implementations does not retain the first SN configuration long enough to resume MR-DC with the SN 106. In other implementations, the UE 102 does not retain 320A the first SN configuration at all after suspending 316A the radio connections. After suspending 316A the radio connections, the UE 102 can perform an RRC resume procedure to transition from the inactive or idle state to the connected state, e.g., in response to determining to initiate a data transmission with the base station 104, or in response to a Paging message received from the base station 104. In response to the determination, the UE 102 can send 322A an RRC resume request message to the MN 104 via cell 124, so that the MN 104 can configure the UE 102 to again operate in the connected state. In response to the RRC resume request message, the MN 104 can determine to resume MR-DC for the UE 102. In response to the determination, the MN 104 can send 328A an SN Modification Request message including an indication to re-establish lower layers for the UE 102 to the SN 106. In some implementations, the MN 104 instead sends 328A the SN Addition Request message to a base station other than the SN 106 to configure the new base station to operate as an SN for the UE 102. The base station sends an SN Addition Request Acknowledge message including a full SN configuration to the MN 104 in response to the SN Addition Request message.

In response to receiving the SN Modification Request message or the indication to re-establish lower layers at event 328A, the SN 106 obtains (e.g., generates) a full SN configuration and sends 332A an SN Modification Request Acknowledge message including the full SN configuration to the MN 104. In some implementations, the SN 106 can allocate resources of lower layers to communicate with the UE 102 in response to the indication to re-establish lower layers. The resources may include software, firmware, memories, and/or processing power that the SN 106 uses to implement functions of the PHY 202A/202B, MAC 204A/204B, and/or RLC 206A/206B layers for communicating with the UE 102, for example. The SN 106 can allocate processing power from an ASIC, DSP, and/or CPU of the SN 106 for communicating with the UE 102.

In some implementations, the MN 104 determines to include the indication to re-establish lower layers for the UE 102 in the SN Modification Request message based on the MN 104 having indicated to the SN 106 to release lower layers at event 308A. In other implementations, the MN 104 determines to include the indication to re-establish lower layers for the UE 102 in the SN Modification Request message based on the MN 104 determining that the UE 102 releases the first SN configuration before transitioning to a connected state (e.g., before resuming radio connectivity or before initiating an RRC resume procedure). In some of these latter implementations, the MN 104 determines that the UE 102 releases the first SN configuration based on a UE capability of the UE 102 (e.g., as discussed in further detail below with reference to FIG. 3B). The UE capability may indicate that the UE 102 is not capable of retaining (i.e., not deleting) an SN configuration (i.e., SCG configuration) upon initiating an RRC resume procedure. The MN 104 may receive the UE capability from the core network 110 (e.g., the AMF 164 or the MME 114) or another base station, or may receive the UE capability in a UECapabilityInformation message from the UE 102 at event 302A. In yet other implementations, the SN 106 is not capable of retaining the first SN configuration while suspending the radio connection with the UE 102 or is not capable of reusing some configurations of the first SN configuration after resuming the radio connection with the UE 102. For example, the SN 106 can release the first SN configuration in response to the SN Modification Request message received at event 308A. In such implementations, the MN 104 includes the indication to re-establish lower layers for the UE 102 in the SN Modification Request message the MN 104 sends at event 328A based on the MN 104 determining that the SN 106 releases the first SN configuration or does not reuse some of the first SN configuration, irrespective of whether the UE 102 is capable of retaining the first SN configuration before transitioning to the connected state.

After receiving 332A the SN Modification Request Acknowledge message, and in response to the RRC resume request message, the MN 104 sends 334A an RRC resume message including the full SN configuration to the UE 102. In response to the RRC resume message, the UE 102 releases 336A the first SN configuration, resumes 338A the suspended radio connection with the MN 104, and transitions to the connected state. The UE 102 can transmit 340A an RRC resume complete message, which may include an RRC reconfiguration complete message, to the MN 104 after resuming 338A the suspended radio connection and in response to the RRC resume message. After receiving 340A the RRC resume complete message, the MN 104 can send 342A an SN Reconfiguration Complete message to the SN 106 to indicate to the SN 106 that the UE 102 successfully received or applied the full SN configuration. In one implementation, the MN 104 can include the RRC reconfiguration complete message from the RRC resume complete message in the SN Reconfiguration complete message.

In the implementation of FIG. 3A, the UE 102 releases 336A the first SN configuration after (e.g., in response to) receiving 334A the RRC resume message. In other implementations, however, the UE 102 may release 336A the first SN configuration at another time (e.g., in response to the RRC suspension message at event 320A instead of retaining the first SN configuration, or upon transmitting 322A the RRC resume request message. In some implementations, the UE 102 retains the radio bearers configured by the MN 104 and/or the SN 106 after receiving 314A the RRC suspension message, and the MN 104 and/or the SN 106 can release or modify one or more of the radio bearers in the RRC resume message transmitted at event 334A, causing the UE 102 to release or modify the radio bearer(s) accordingly. For example, the MN 104 can include one or more radio bearer configurations (e.g., RadioBearerConfig information element(s)) in the RRC resume message to release, add or modify one or more radio bearers, causing the UE 102 to release, add, or modify the radio bearer(s) accordingly. The MN 104 can receive the one or more radio bearer configurations from the SN 106 and include the one or more radio bearer configurations in the RRC resume message.

At some point after receiving 334A the full SN configuration, the UE 102 can perform 344A a random access procedure on the cell 126 and with the SN 106 to connect to the SN 106 using one or more random access configurations in the full SN configuration. After the UE 102 successfully completes the random access procedure on the cell 126, the UE 102 can communicate 346A data (user-plane data and/or control-plane data) in DC with both the MN 104 and the SN 106 through the cell 126. Having identified the UE 102 in the random access procedure, the SN 106 can communicate 346A data (user-plane data or control-plane data) with the UE 102 in accordance with the full SN configuration the UE 102 received at event 334A. The events 334A, 336A, 338A, 340A, 342A, 344A, and 346A are collectively referred to in FIG. 3A as an MR-DC resume procedure 360A.

The random access procedure can be a four-step random access procedure or a two-step random access procedure, for example. In different implementations and/or scenarios, the random access procedure may be a contention-based random access procedure or a contention-free random access procedure. In some implementations and/or scenarios, the UE 102 may include a UE identifier known by the SN 106 in a “message 3” of a four-step random access procedure, or in a message A of the two-step random access procedure, so that the SN 106 can identify the UE 102 using the UE identifier. In some implementations, the UE identifier is a radio network temporary identifier (RNTI) (e.g., a C-RNTI) allocated by the SN 106 in the full SN configuration. In other implementations, the SN 106 identifies the UE 102 based on a dedicated random access preamble that the SN 106 receives from the UE 102 during the random access procedure. The SN 106 can allocate the dedicated random access preamble in the full SN configuration.

The MN 104 and the SN 106 can include the at least one interface ID of the UE 102, as discussed above, in the messages transmitted between the MN 104 and the SN 106. For example, the MN 104 can include the interface ID(s) in the SN Modification Request messages the MN 104 transmits at events 308A and 328A, and in the SN Reconfiguration Complete message the MN 104 transmits at event 342A. The SN 106 can include the interface ID(s) in the SN Modification Request Acknowledge messages the SN 106 transmits at events 312A and 332A.

In some implementations, the MN 104 can also include a second MN configuration in the RRC resume message the MN 104 transmits at event 334A, in which case, the UE 102 communicates 346A with the MN 104 using the second MN configuration. In one implementation, the MN 104 can generate the second MN configuration as a full MN configuration which completely replaces the first MN configuration. Accordingly, the UE 102 can 346A communicate with the MN 104 using the full MN configuration. In another implementation, the MN 104 generates the second MN configuration as a delta MN configuration which augments only a portion of the first MN configuration. Accordingly, the UE 102 communicates 346A with the MN 104 using the delta MN configuration and the portion of the first MN configuration that is not augmented by the delta MN configuration.

The first MN configuration can include multiple configuration parameters that configure radio resources for the UE 102 to communicate with the MN 104 via a PCell (e.g., the cell 124 or a cell other than cell 124) and zero, one, or more secondary cells (SCells) of the MN 104. For example, the first MN configuration can include PHY configuration(s), MAC configuration(s), and/or RLC configuration(s). In another example, the first MN configuration can include one or more measurement configurations. The first MN configuration can include one or more radio bearer configurations configuring one or more radio bearers. The UE 102 may receive the multiple configuration parameters in one or more RRC messages from the MN 104.

In some implementations, the MN configuration (i.e., the first MN configuration and/or the second MN configuration) includes configuration parameters in an RRCReconfiguration message, RRCReconfiguration-IEs, or the CellGroupConfig information element (IE) conforming to 3GPP TS 38.331. In one implementation, the MN configuration can be an RRCReconfiguration message, RRCReconfiguration-IEs, or the CellGroupConfig IE conforming to 3GPP TS 38.331. In other implementations, the MN configuration can include configuration parameters in a RadioResourceConfigDedicated IE, RRCConnectionReconfiguration message, or RRCConnectionReconfiguration-IEs. In one implementation, the MN configuration can be a RadioResourceConfigDedicated IE, a RRCConnectionReconfiguration message, or a RRCConnectionReconfiguration-IEs conforming to 3GPP TS 36.331.

The SN configuration (e.g., the first SN configuration and/or the second SN configuration) can include multiple configuration parameters that configure radio resources for the UE 102 to communicate with the SN 106 via a PSCell (e.g., the cell 126 or a cell other than cell 126) and zero, one, or more SCells of the SN 106. For example, the SN configuration can include PHY configuration(s), MAC configuration(s), and/or RLC configuration(s). The SN configuration may or may not include measurement configuration(s). The first SN configuration may not include one or more radio bearer configurations configuring one or more radio bearers. The second SN configuration can be a complete and self-contained configuration (i.e. a full configuration). The UE 102 can use the full SN configuration to communicate with the SN 106 without relying on the first SN configuration. The UE 102 may receive the multiple configuration parameters in one or more RRC messages from the SN 106, e.g., via the MN 104 or on an SRB (e.g., SRB3) that the MN 104 or SN 106 configures to exchange RRC messages between the UE 102 and the SN 106.

In some implementations, the SN configuration includes configuration parameters in an RRCReconfiguration message, RRCReconfiguration-IEs, or a CellGroupConfig IE conforming to 3GPP TS 38.331. In one implementation, the SN configuration can be an RRCReconfiguration message, RRCReconfiguration-IEs, or a CellGroupConfig IE conforming to 3GPP TS 38.331. In other implementations, the SN configuration can include configuration parameters in an SCG-ConfigPartSCG-r12 IE. In some implementations, the SN configuration can be a RRCConnectionReconfiguration message, RRCConnectionReconfiguration-IEs, or a ConfigPartSCG-r12 IE conforming to 3GPP TS 36.331.

In some implementations where the MN 104 is a gNB, the RRC resume request message, the RRC resume message, and the RRC resume complete message can be an RRCResumeRequest message, an RRCResume message, and an RRCResumeComplete message. In other implementations where the MN 104 is an eNB or ng-eNB, the RRC resume request message, the RRC resume message, and the RRC resume complete message can be an RRCConnectionResumeRequest message, an RRCConnectionResume message, or an RRCConnectionResumeComplete message.

Referring next to FIG. 3B, a scenario 300B involves another MR-DC resumption procedure. In scenario 300B, the base station 104 operates as an MN and the base station 106 operates as an SN. As mentioned above, events in the scenario 300B similar to those discussed above with respect to the scenario 300A are labeled with similar reference numbers (e.g., with event 302A of FIG. 3A corresponding to event 302B of FIG. 3B). With the exception of the differences shown in FIG. 3B and the differences described below, any of the alternative implementations discussed above with respect to the scenario 300A (e.g., for messaging and processing) may apply to the scenario 300B.

Events 302B, 304B, and 306B may be similar to events 302A, 304A, and 306A, respectively. In response to the determination 306B, the MN 104 sends 309B to the SN 106 an SN Modification Request message including an indication to suspend lower layers (e.g., PHY 202A/202B, MAC 204A/204B, and/or RLC 206A/206B) for communicating with the UE 102. In response to the SN Modification Request message, the SN 106 suspends 311B the lower layers and sends 312B an SN Modification Request Acknowledge message to the MN 104. In some implementations, the SN 106 can release resources of lower layers allocated to communicate with the UE 102 in response to the indication to suspend lower layers. These resources can include software, firmware, memories, and/or processing power that the SN 106 uses to implement functions of the PHY 202A/202B, MAC 204A/204B, and/or RLC 206A/206B layers for communicating with the UE 102. For example, the SN 106 can allocate processing power from an ASIC, DSP and/or CPU of the SN 106 for communicating with the UE 102, and release the allocated processing power in response to the indication to suspend lower layers. In other implementations, the SN 106 retains the resources of lower layers allocated to communicate with the UE 102 despite receiving the indication to suspend lower layers, and despite suspending operation of the PHY 202A/202B, MAC 204A/204B, and/or RLC 206A/206B layers (i.e., despite suspending communication with the UE 102).

In yet other implementations, the SN 106 may retain or release the first SN configuration or a portion of the first SN configuration in response to the indication to suspend lower layers. In some implementations, the SN 106 can retain at least one interface ID of the UE 102 for exchanging interface messages between the MN 104 and the SN 106 in response to the indication to suspend lower layers. For example, if the interface between the MN 104 and the SN 106 is an Xn interface (e.g., as shown in FIG. 1A), the interface ID(s) can include a first UE XnAP ID allocated by the SN 106, and a second UE XnAP ID allocated by the MN 104. In another example, if the interface between the MN 104 and the SN 106 is an X2 interface, the at least one interface ID can include a first UE X2AP ID allocated by the SN 106, and a second UE X2AP ID allocated by the MN 104.

The events 314B, 316B, and 318B may be similar to events 314A, 316A, and 318A, respectively. The events 302B, 304B, 306B, 309B, 311B, 312B, 314B 316B, and 318B are collectively referred to in FIG. 3B as an MR-DC suspension procedure 351B.

The events 320B and 322B may be similar to events 320A and 322A, respectively. In response to the RRC resume request message the MN 104 receives at event 322B, the MN 104 can determine to resume MR-DC for the UE 102. In response to the determination, the MN 104 can send 327B to the SN 106 an SN Modification Request message including an indication to resume lower layers (e.g., PHY 202A/202B, MAC 204A/204B, and/or RLC 206A/206B) for communicating with the UE 102. Before sending 327B the SN Modification Request message, the MN 104 determines 324B that the UE 102 releases the first SN configuration. The MN 104 can make the determination 324B based on a UE capability of the UE 102, as discussed above. The UE capability may indicate that the UE 102 is not capable of retaining (i.e., not deleting) an SN configuration (i.e., SCG configuration) upon initiating an RRC resume procedure. The MN 104 may receive the UE capability from the core network 110 (e.g., the AMF 164 or the MME 114) or another base station, or may receive the UE capability in a UECapabilityInformation message from the UE 102 at event 302B. In some implementations, the MN 104 can send 327B an SN Modification Request message including an indication to re-establish lower layers for communicating with the UE 102 instead of the indication to resume lower layers, similar to the event 328A.

If the MN 104 determines 324B that the UE releases the first SN configuration before resuming radio connectivity (or determines that the UE 102 for other reasons cannot apply the first SN configuration when resuming radio connectivity), the MN 104 includes a full configuration request (e.g., a Full Configuration IE) in the SN Modification Request message. The full configuration request is an indication to the SN 106 to provide a full SN configuration. In response to the SN Modification Request message 327B or the full configuration request, the SN 106 obtains (e.g., generates) a full SN configuration and sends 332B to the MN 104 an SN Modification Request Acknowledge message that includes the full SN configuration. In some implementations, the SN 106 can allocate resources of lower layers to communicate with the UE 102 in response to the indication to resume lower layers. The resources may include software, firmware, memories, and/or processing power that the SN 106 uses to implement functions of the PHY 202A/202B, MAC 204A/204B, and/or RLC 206A/206B layers for communicating with the UE 102. The SN 106 can allocate processing power from the ASIC, DSP, and/or CPU of the SN 106 for communicating with the UE 102. In other implementations, if the SN 106 retains the resources of lower layers allocated to communicate with the UE 102 despite receiving the indication to suspend lower layers at event 309B, the SN 106 resumes operation of the PHY 202A/202B, MAC 204A/204B, and/or RLC 206A/206B layers, such that the SN 106 resumes communication with the UE 102 using the retained resources. In this latter case, the SN 106 may or may not modify the retained resources before resuming communication.

In some implementations, the MN 104 determines to include the indication to resume lower layers for communicating with the UE 102 in the SN Modification Request message transmitted at event 327B based on the MN 104 having indicated to the SN 106 to suspend lower layers at event 309B.

After the MN 104 receives 332B the SN Modification Request Acknowledge message, the MN 104 can transmit the full SN configuration to the UE 102 during an MR-DC resume procedure 360B, which may be similar to the MR-DC resume procedure 360A. The UE 102 can then communicate in DC with the MN 104 and with the SN 106 in accordance with the full SN configuration.

In some implementations, the SN 106 is not capable of retaining the first SN configuration while suspending the radio connection with the UE 102 or is not capable of reusing some configurations of the first SN configuration after resuming the radio connection with the UE 102. For example, the SN 106 can release the first SN configuration in response to receiving 309B the SN Modification Request message. In such implementations, the MN 104 includes the full configuration request in the SN Modification Request Acknowledge message the MN 104 sends at event 327B based on the MN 104 determining that the SN 106 releases the first SN configuration or does not reuse some of the first SN configuration, irrespective of whether the UE 102 is capable of retaining the first SN configuration before transitioning to the connected state.

Referring next to FIG. 3C, in a scenario 300C, the base station 104 operates as an MN, and the base station 106 operates as an SN. The scenario 300C is generally similar to the scenario 300B, but with the SN 106, rather than the MN 104, determining 325C that the UE 102 releases the first SN configuration. With the exception of the differences shown in FIG. 3C and the differences described below, any of the alternative implementations discussed above with respect to the scenario 300B (e.g., for messaging and processing) may apply to the scenario 300C.

The events 351C, 320C, and 322C may be similar to the events 351B, 320B, and 322B, respectively. Thereafter, the MN 104 sends 329C to the SN 106 an SN Modification Request message including an indication to resume lower layers for communicating with the UE 102. Unlike the message the MN 104 sends at event 327B, the SN Modification Request message does not include a full configuration request because the MN 104 does not determine whether the UE 102 releases the first SN configuration. Rather, the SN 106 determines 325C that the UE 102 releases the first SN configuration before resuming radio connectivity, similar the determination 324B of the MN 104. The SN 106 can determine that the UE 102 releases the first SN configuration based on a UE capability of the UE 102. The SN 106 may receive the UE capability from another base station, the core network 110, or in a UECapabilityInformation message from the UE 102 at event 302C, for example.

In response to the determination 325C, the SN 106 obtains (e.g., generates) a full SN configuration. The SN 106 sends 333C an SN Modification Request Acknowledge message including the full SN configuration and a full configuration indication (e.g., an IE that indicates to the MN 104 that the configuration is a full SN configuration) to the MN 104.

After the MN 104 receives 333C the SN Modification Request Acknowledge message, the MN 104 can transmit the full SN configuration to the UE 102 during an MR-DC resume procedure 360C, which may be similar to the MR-DC resume procedure 360B.

In some implementations, the SN 106 is not capable of retaining the first SN configuration while suspending the radio connection with the UE 102 or is not capable of reusing some configurations of the first SN configuration after resuming the radio connection with the UE 102. For example, the SN 106 can release the first SN configuration in response to receiving 309B the SN Modification Request message. In such implementations, the SN obtains (e.g., generates) a full SN configuration and sends 333C the SN Modification Request Acknowledge message to the MN 104 because the SN 106 releases the first SN configuration or does not reuse some of the first SN configuration, irrespective of whether the UE 102 is capable of retaining the first SN configuration before transitioning to the connected state.

Referring next to FIG. 3D, in a scenario 300D, the base station 104 operates as an MN, and the base station 106 operates as an SN. The scenario 300D is generally similar to the scenario 300B, but with the MN 104 determining that the UE 102 does not release the first SN configuration. With the exception of the differences shown in FIG. 3D and the differences described below, any of the alternative implementations discussed above with respect to the scenario 300B (e.g., for messaging and processing) may apply to the scenario 300D.

The events 351D, 320D, and 322D may be similar to the events 351B, 320B, and 322B. Thereafter, the MN 104 determines 326D that the UE 102 does not release the first SN configuration before (or upon) resuming radio connectivity. The MN 104 can make the determination 326D based on a UE capability, such as a UE capability received from another base station, the core network 110, or the UE 102. The UE capability may indicate, for example, that the UE 102 retains (i.e., does not delete) an SN configuration upon initiating an RRC resume procedure. In response to the determination 326D, the MN 104 sends 329D to the SN 106 an SN Modification Request message including an indication to resume lower layers, but not including a full configuration request.

In some implementations, the MN 104 can determine whether the SN 106 is capable of retaining the first SN configuration while suspending the radio connection with the UE 102 or is capable of reusing some configurations of the first SN configuration after resuming the radio connection with the UE 102. If the SN 106 is capable of retaining the first SN configuration while suspending the radio connection with the UE 102 or is capable of reusing some configurations of the first SN configuration after resuming the radio connection with the UE 102, the MN 104 sends 329D to the SN 106 the SN Modification Request message including the indication to resume lower layers, as depicted in FIG. 3D. Otherwise, the MN 104 sends 329D to the SN 106 an SN Modification Request message including an indication to re-establish lower layers, similar to the message sent at event 328A, or including an indication to resume lower layers and including a full configuration request, similar to the message sent at event 327B.

In response to receiving 329D the message, the SN 106 obtains (e.g., generates) a delta SN configuration and sends 331D the delta SN configuration to the MN 104 including the delta SN configuration. Unlike a full SN configuration (i.e., a complete and self-contained configuration), the delta SN configuration includes only a subset of configuration parameters, i.e., only those configuration parameters that the SN 106 is changing relative to the first SN configuration). The delta SN configuration augments or modifies a portion of the first SN configuration.

The MN 104 sends 335D an RRC resume message including the delta SN configuration to the UE 102 in response to the RRC resume request message. In response to the RRC resume message, the UE 102 resumes 338D the suspended radio connection with the MN 104 and transitions to the connected state. The UE 102 can transmit 340D an RRC resume complete message including an RRC reconfiguration complete message to the MN 104 in response to the RRC resume message. After receiving 340D the RRC resume complete message, the MN 104 sends 342D to the SN 106 an SN Reconfiguration Complete message to indicate to the SN 106 that the UE 102 successfully received or applied the delta SN configuration. In one implementation, the MN 104 can include the RRC reconfiguration complete message from the RRC resume complete message in the SN Reconfiguration Complete message.

The UE 102 can perform 344D a random access procedure on the cell 126 and with the SN 106 to connect to the SN 106 using one or more random access configurations in the delta SN configuration, or in the portion of the first SN configuration not augmented by the delta SN configuration. If the UE 102 successfully performs the random access procedure, then the UE 102 communicates 346D in DC with the MN and with the SN using the delta SN configuration and the portion of the first SN configuration not augmented by the delta SN configuration. The events 335D, 338D, 340D, 342D, 344D, and 346D are collectively referred to in FIG. 3D as an MR-DC resume procedure 361D.

Referring next to FIG. 3E, in a scenario 300E, the base station 104 operates as an MN, and the base station 106 operates as an SN. The scenario 300E is generally similar to the scenario 300D, but with the SN 106, rather than the MN 104, determining that the UE 102 does not release the first SN configuration. With the exception of the differences shown in FIG. 3E and the differences described below, any of the alternative implementations discussed above with respect to the scenario 300D (e.g., for messaging and processing) may apply to the scenario 300E.

The events 351E, 320E, and 322E may be similar to the events 351D, 320D, and 322D. The MN 104 sends 329D to the SN 106 an SN Modification Request message including an indication to resume lower layers for communicating with the UE 102. Thereafter, the SN 106 determines 330E that the UE 102 does not release the first SN configuration before resuming radio connectivity. The SN 106 can make the determination 330E based on a UE capability, such as a UE capability received from another base station, the core network 110, or the UE 102, similar to the determination the MN 104 makes at 326D. In response to the determination 330E, the SN 105A obtains (e.g., generates) a delta SN configuration and sends 331E to the MN 104 an SN Modification Request Acknowledge message including the delta SN configuration.

The MN 104 sends the delta SN configuration to the UE 102 at event 361E, which may be similar to the MR-DC resume procedure 361D. The UE 102 can then communicate in DC with the MN 104 and with the SN 106 in accordance with the delta SN configuration and a portion of the first SN configuration.

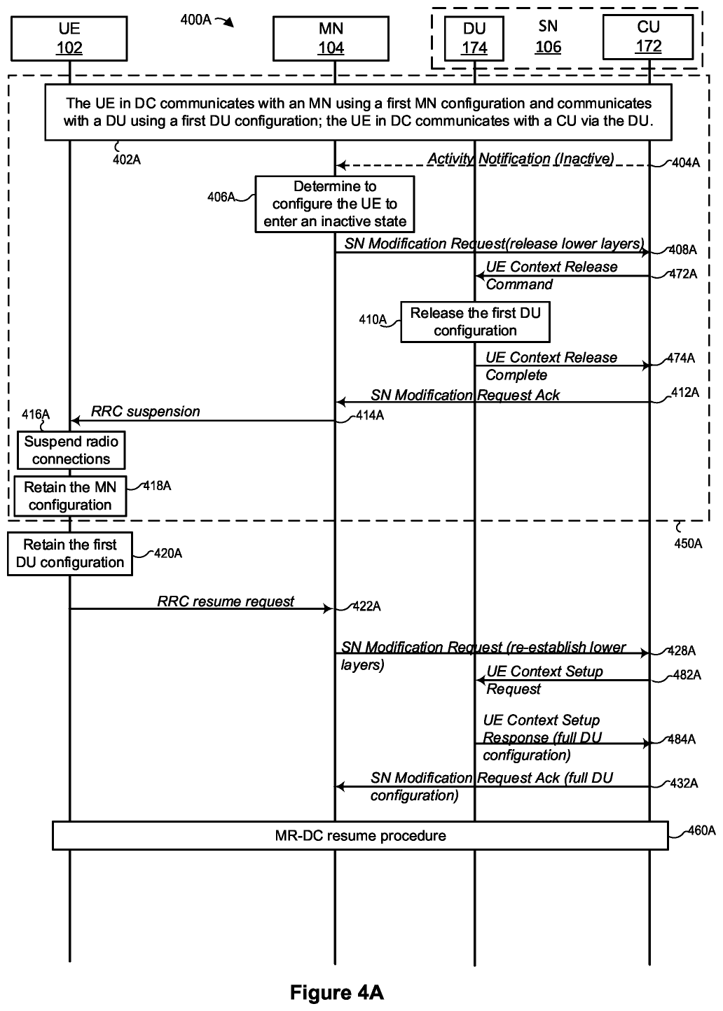

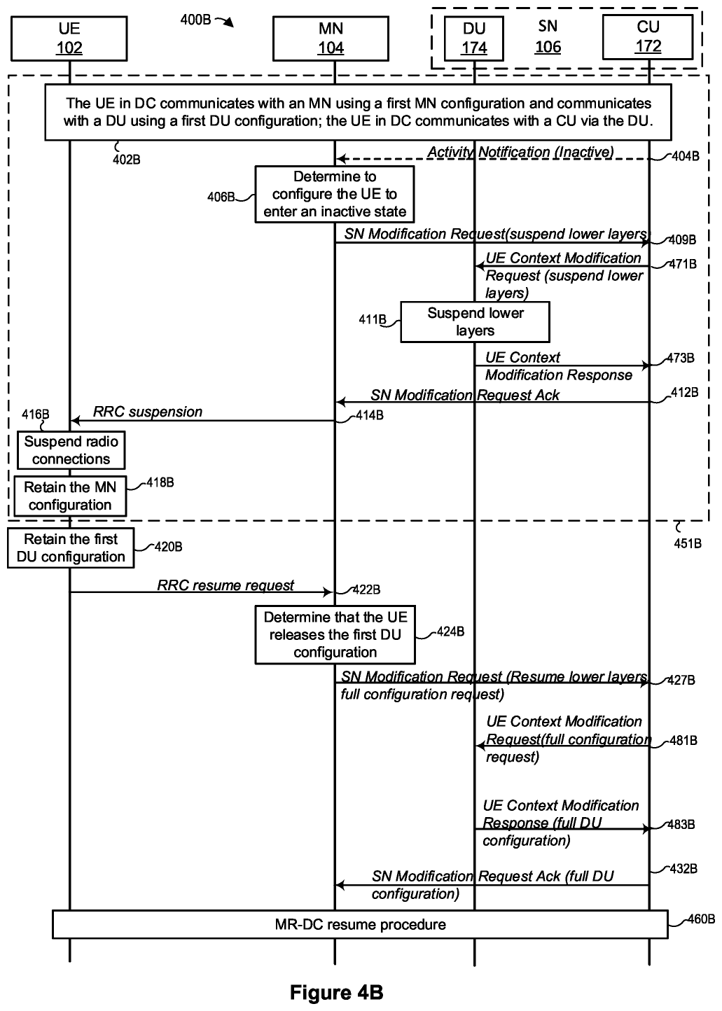

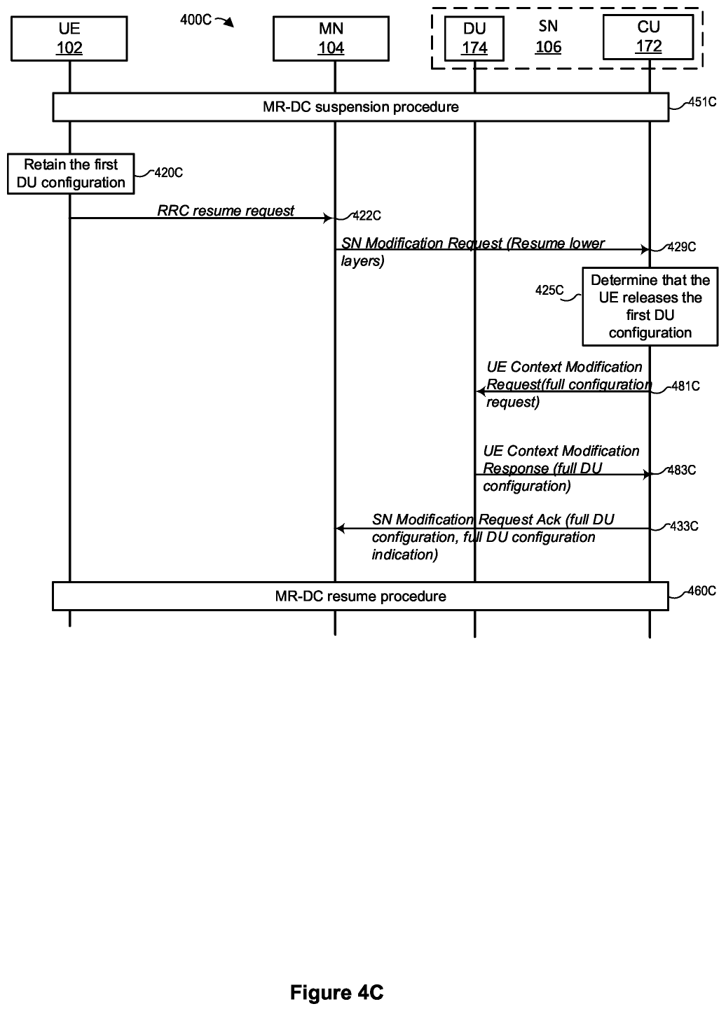

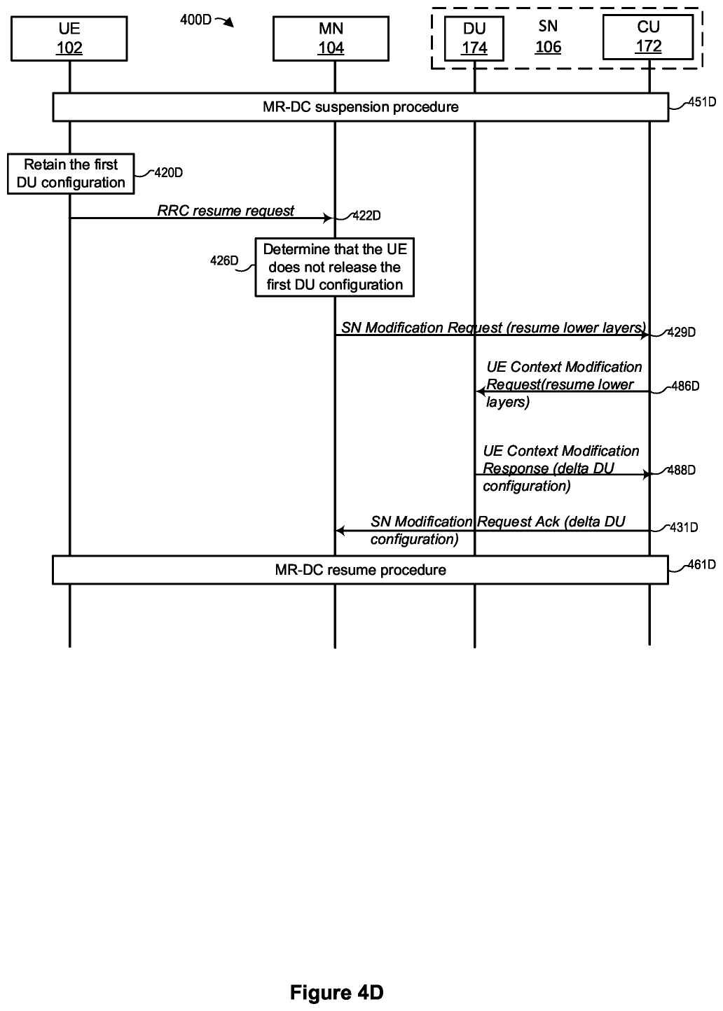

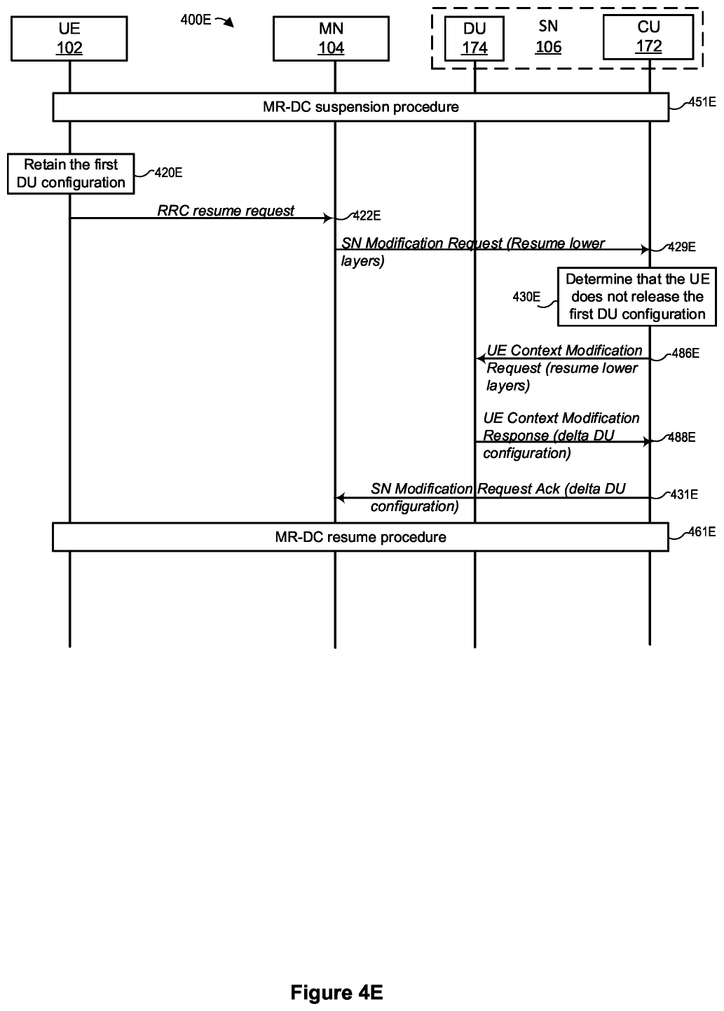

FIGS. 4A-4E are example message sequences similar to FIGS. 3A-3E, but where the SN 106 includes both a CU and a DU. Accordingly, events in the scenarios depicted in FIGS. 4A-4E and similar to those discussed with respect to FIGS. 3A-3E are labeled with similar reference numbers (e.g., with event 402A being similar to event 302A or 302B, etc.). With the exception of the differences shown in the figures and the differences described below, any of the alternative implementations discussed above with respect to the scenarios 300A-E (e.g., for messaging and processing) may apply to the scenarios 400A-E, respectively.

Turning first to FIG. 4A, in a scenario 400A, the base station 104 operates as an MN, and the base station 106 operates as an SN that includes a CU 172 and a DU 174. The scenario 400A is generally similar to the scenario 300A, with the exception that the SN 106 includes the CU 172 and the DU 174. Accordingly, at the start of the scenario 400A, the UE 102 communicates 402A in DC with the MN 104 in accordance with a first MN configuration, with the DU 174 in accordance with a first DU configuration, and with the CU 172 via the DU 174. The MN 104 then determines 406A to configure the UE 102 to enter an inactive state, or an idle state with a suspended radio connection, similar to event 306A.

In response to the determination 406A, the MN 104 sends 408A to the CU 172 an SN Modification Request message that includes an indication to release lower layers (e.g., PHY 202A/202B, MAC 204A/204B, and/or RLC 206A/206B) for communicating with the UE 102. In response to the indication to release lower layers, the CU 172 sends 472A to the DU 174 a UE Context Release Command message. In response to the UE Context Release Command message, the DU 174 releases resources of lower layers allocated to communicate with the UE 102. These resources can include software, firmware, memories, and/or processing power that the DU 174 uses to implement functions of the PHY 202A/202B, MAC 204A/204B, and/or RLC 206A/206B layers for communicating with the UE. For example, the DU 174 can release processing power from the ASIC, DSP, and/or CPU of the DU 174 allocated to communicate with the UE 102. In the example scenario 400A, the DU 174 also or instead releases 410A the first DU configuration in response to the UE Context Release Command message. The DU 174 sends 474A a UE Context Release Complete message to the CU 172 in response to the UE Context Release Command message. In some implementations, the CU 172 can release at least one interface ID of the UE 102 for exchanging interface messages between the CU 172 and the DU 174 after receiving 474A the UE Context Release Complete message. Similarly, the DU 174 can release the at least one interface ID after transmitting 474A the UE Context Release Complete message. For example, the at least one interface ID can include a first UE FLAP ID allocated by the DU 174, and a second UE F1AP ID allocated by the CU 172.

The CU 172 can then send 412A to the MN 104 an SN Modification Request Acknowledge message. Events 414A, 416A, and 418A may be similar to the events 314A, 316A, and 318A, respectively, with the exception that the UE 102 suspends 416A radio connections with the MN 104 and the DU 174. The events 402A, 404A, 406A, 408A, 472A, 410A, 474A, 412A, 414A, 416A, and 418A are collectively referred to in FIG. 4A as an MR-DC suspension procedure 450A. The event 420A may be similar to the event 320A, with the exception that the UE 102 retains or releases the first DU configuration rather than a first SN configuration.

At a later time, the UE 102 sends 422A to the MN 104 an RRC resume request message, and, in response, the MN 104 sends 428A an SN Modification Request message to the CU 172 including an indication to re-establish lower layers. As discussed above with respect to event 328A, the indication may be to establish lower layers. For example, MN 104 may send 428A the SN Addition Request to another base station that did not previously communicate with the UE 102, and the base station may need to (newly) establish lower layers for communicating with the UE 102 rather than re-establishing lower layers. The base station sends a SN Addition Request Acknowledge message including a full SN configuration to the MN 104 in response to the SN Addition Request message.

In response to receiving 428A the SN Modification Request, the CU 172 sends 482A to the DU 174 a UE Context Setup Request message. In response to the UE Context Setup Request, the DU 174 obtains (e.g., generates), a full DU configuration for the UE 102 to use to communicate with the DU 174. In some implementations, the DU 174 can allocate resources of lower layers to communicate with the UE 102 in response to the UE Context Setup Request. The resources may include software, firmware, memories, and/or processing power that the DU 174 uses to implement functions of the PHY 202A/202B, MAC 204A/204B, and/or RLC 206A/206B layers for communicating with the UE 102. The DU 174 can allocate processing power from an ASIC, DSP, and/or CPU of the DU 174 for communicating with the UE 102.

The DU 174 sends 484A the full DU configuration to the CU 172, and the CU 172 sends 432A to the MN 104 an SN Modification Request Acknowledge message including the full DU configuration. The MN 104 transmits the full DU configuration to the UE 102 and the UE 102 resumes the suspended radio connections with the MN 104 and the DU 174 during an MR-DC resume procedure 460A. The MR-DC resume procedure 460A may be generally similar to the MR-DC resume procedure 360A, with the exception that the UE 102 releases the first DU configuration, the UE 102 performs a random access procedure with the SN 106 by exchanging messages (e.g., random access preamble, random access response, message 3 or message A) with the DU 174, and, after successfully performing the random access procedure, the UE 102 communicates in DC with the MN 104, with the DU 174 in accordance with the full DU configuration, and with the CU 172 via the DU 174.

Referring next to FIG. 4B, in a scenario 400B, the base station 104 operates as an MN, and the base station 106 operates as an SN that includes a CU 172 and a DU 174. The scenario 400B is generally similar to the scenario 400A, but with the MN 104 determining that the UE 102 releases the first DU configuration. The scenario 400B is also generally similar to the scenario 300B, but with the SN 106 including the CU 172 and the DU 174.

Events 402B, 404B, 406B may be similar to the events 402A, 404A, and 406A, respectively. In response to the determination 406B, the MN 104 sends 409B to the CU 172 an SN Modification Request message including an indication to suspend lower layers (e.g., PHY 202A/202B, MAC 204A/204B, and/or RLC 206A/206B) for communicating with the UE 102. In response, the CU 172 sends 471B to the DU 174 a UE Context Modification Request message including an indication to suspend lower layers. Accordingly, the DU 174 suspends 411B lower layers for communicating with the UE 102 and sends 473B a UE Context Modification Response message to the CU 172. In some implementations, the DU 174 can release resources of lower layers allocated to communicate with the UE 102 in response to the indication to suspend lower layers. These resources can include software, firmware, memories, and/or processing power that the DU 174 uses to implement functions of the PHY 202A/202B, MAC 204A/204B, and/or RLC 206A/206B layers for communicating with the UE 102. For example, the DU 174 can allocate processing power from the ASIC, DSP and/or CPU of the DU 174 for communicating with the UE 102, and release the allocated processing power in response to the indication to suspend lower layers. In other implementations, the DU 174 can retain the resources of lower layers allocated to communicate with the UE 102 despite receiving the indication to suspend lower layers, and despite suspending operation of the PHY 202A/202B, MAC 204A/204B, and/or RLC 206A/206B layers (i.e., despite thereby suspending communication with the UE 102). The DU 174 may retain or release the first DU configuration or a portion of the first DU configuration in response to the indication to suspend lower layers. In some implementations, the CU 172 can retain at least one interface ID of the UE 102 for exchanging interface messages between the CU 172 and the DU 174 after receiving 473B the UE Context Modification Response message. Similarly, the DU 174 can retain the at least one interface ID after transmitting 473B the UE Context Modification Response message. For example, the at least one interface ID can include a first UE F1AP ID allocated by the DU 174, and a second UE F1AP ID allocated by the CU 172.

After receiving 473B the UE Context Modification Response message, the CU 172 sends 412B to the MN 104 an SN Modification Request Acknowledge message. The events 412B, 414B, 416B, and 418B may be similar to the events 412A, 414A, 416A, and 418A. The events 402B, 404B, 406B, 409B, 471B, 411B, 473B, 412B, 414B, 416B, and 418B are collectively referred to herein as an MR-DC suspension procedure 451B.

The events 420B and 422B may be similar to events 420A and 422A, respectively. In response to the RRC resume request message the MN 104 receives at event 422B, the MN 104 determines to resume MR-DC for the UE 102. In response to the determination, the MN 104 sends 427B an SN Modification Request message including an indication to resume lower layers (e.g., PHY 202A/202B, MAC 204A/204B, and/or RLC 206A/206B) for communicating with the UE 102 to the CU 172. Before sending 427B the SN Modification Request message, the MN 104 determines 424B that the UE 102 releases the first DU configuration. The MN 104 can make the determination 424B based on a UE capability of the UE 102, as discussed above. The MN 104 may receive the UE capability from the core network 110 (e.g., the AMF 164 or the MME 114) or another base station, or may receive the UE capability in a UECapabilityInformation message from the UE 102 at event 402B, for example.

If the MN 104 determines 424B that the UE 102 releases the first DU configuration before resuming radio connectivity (or determines that the UE 102 for other reasons cannot apply the first DU configuration when resuming radio connectivity), the MN 104 includes a full configuration request (e.g., Full Configuration IE) in the SN Modification Request message. The full configuration request is an indication to the SN 106 (or, more particularly, to the DU 174) to provide a full DU configuration. In some implementations, the MN 104 determines to include the indication to resume lower layers for communicating with the UE 102 in the SN Modification Request message at event 427B based on the MN 104 having indicated to the SN 106 to suspend lower layers at event 409B.

In response to receiving 427B the SN Modification Request message or the full configuration request, the CU 172 sends 481B to the DU 174 a UE Context Modification Request message including an indication to provide a full configuration. In some implementations, the UE Context Modification Request message also includes an indication to resume lower layers for communicating with the UE. In response to the UE Context Modification Request message, the DU 174 obtains (e.g., generates) a full DU configuration and sends 483B a UE Context Modification Response to the CU 172 including the full DU configuration. In some implementations, the DU 174 can allocate resources of lower layers to communicate with the UE 102 in response to the UE Context Modification Request message. The resources may include software, firmware, memories, and/or processing power that the SN 106 uses to implement functions of the PHY 202A/202B, MAC 204A/204B, and/or RLC 206A/206B layers for communicating with the UE 102. The DU 174 can allocate processing power from the ASIC, DSP, and/or CPU of the DU 174 for communicating with the UE 102. In other implementations, if the DU 174 retains the resources of lower layers allocated to communicate with the UE 102 despite receiving the indication to suspend lower layers at event 409B, the DU 174 resumes operation of the PHY 202A/202B, MAC 204A/204B, and/or RLC 206A/206B layers, such that the DU 174 resumes communication with the UE 102 using the retained resources. In this latter case, the DU 174 may or may not modify the retained resources before resuming communication.

In some implementations, the MN 104 can send 427B an SN Modification Request message including an indication to re-establish lower layers for communicating with the UE 102 instead of the indication to resume lower layers, similar to the event 428A. In such implementations, the CU 172 can send 481B the UE Context Modification Request message to the DU 174, and the DU 174 can send 483B the UE Context Modification Response message to the CU 172 in response. Alternatively, instead of the messages the CU 172 and the DU 174 exchange at 481B and 483B, the CU 172 can send a UE Context Setup Request message to the DU 174 and the DU 174 can send a UE Context Setup Response message to the CU 172 in response, similar to the events 482A and 484A.

After receiving 483B the UE Context Modification Response including the full DU configuration, the CU 172 sends 432B to the MN 104 an SN Modification Request Acknowledge message including the full DU configuration.

In some implementations, the MN 104 determines to include the indication to resume lower layers for communicating with the UE 102 in the SN Modification Request message at event 427B based on the MN 104 having indicated to the SN 106 to suspend lower layers at event 409B. The MN 104 can transmit the full DU configuration to the UE 102 during an MR-DC resume procedure 460B, which may be similar to the MR-DC resume procedure 460A. The UE 102 can then communicate in DC with the MN 104, with the DU 174 in accordance with the full DU configuration, and with the CU 172 via the DU 174.

The CU 172 and the DU 174 can include the at least one interface ID of the UE 102, as discussed above, in the messages transmitted between the CU 172 and the DU 174. For example, the CU 172 can include the interface ID(s) in the UE Context Modification Request messages the CU 172 transmits at events 471B and 481B. The DU 174 can include the interface ID(s) in the UE Context Modification Response messages the DU 174 transmits at events 473B and 483B.

Referring next to FIG. 4C, in a scenario 400C, the base station 104 operates as an MN, and the base station 106 operates as an SN that includes a CU 172 and a DU 174. The scenario 400C is generally similar to the scenario 400B, but with the SN 106 (and more particularly, the CU 172), determining 425C that the UE 102 releases the first DU configuration. The scenario 400C is also generally similar to the scenario 300C, but with the SN 106 including the CU 172 and the DU 174.

The events 451C, 420C, and 422C may be similar to the events 451B, 420B, and 422B, respectively. Thereafter, the MN 104 sends 429C an SN Modification Request message to the CU 172 including an indication to resume lower layers. The CU 172 determines 425C that the UE 102 releases the first DU configuration before resuming radio connectivity (or determines that the UE 102 for other reasons cannot apply the first DU configuration when resuming radio connectivity), similar to the determination 424B of the MN 104. The CU 172 can determine that the UE 102 releases the first DU configuration based on a UE capability of the UE 102. The CU 172 may receive the UE capability from the DU 174, another base station, the core network 110, or in a UE Capability Information message from the UE 102 at event 402C, for example.

In response to the determination 425C, the CU 172 sends 481C to the DU 174 a UE Context Modification Request message including a full configuration request. The UE Context Modification Request may also include an indication to resume lower layers for communicating with the UE 102. The DU 174 obtains (e.g., generates) a full DU configuration for the UE 102 to use to communicate with the DU 174, and sends 483C a UE Context Modification Response message to the CU 172 including the full DU configuration. The CU 172 sends 433C to the MN 104 an SN Modification Request Acknowledge message including the full DU configuration. The SN Modification Request Acknowledge message may also include a full configuration indication (e.g., an IE that indicates to the MN 104 that the configuration is a full DU configuration). The MN 104 can transmit the full DU configuration to the UE 102 during an MR-DC resume procedure 460C, which may be similar to the MR-DC resume procedure 460B.

Referring next to FIG. 4D, in a scenario 400D, the base station 104 operates as an MN, and the base station 106 operates as an SN that includes a CU 172 and a DU 174. The scenario 400D is generally similar to the scenario 300D, but with the exception that the SN 106 includes the CU 172 and the DU 174. The scenario 400D is also generally similar to the scenario 400B, but with the MN 104 determining that the UE 102 does not release the first DU configuration.

The events 451D, 420D, and 422D may be similar to the events 451B, 420B, and 422B. Thereafter, in the scenario 400D, the MN 104 determines 426D that the UE 102 does not release the first DU configuration before resuming radio connectivity. The MN 104 can make the determination 426D based on a UE capability, such as a UE capability received from another base station, the core network 110, or the UE 102. The UE capability may indicate, for example, that the UE 102 retains (i.e., does not delete) a DU configuration upon initiating an RRC resume procedure. In response to the determination 426D, the MN 104 sends 429D to the CU 172 an SN Modification Request message including an indication to resume lower layers, but not including a full configuration request.

In response to receiving 429D the message, the CU 172 sends 486D to the DU 174 a UE Context Modification Request message including an indication to resume lower layers for communicating with the UE 102. In response, the DU 174 obtains (e.g., generates) a delta DU configuration that augments or modifies a portion of the first DU configuration. The DU 174 sends 488D to the CU 172 a UE Context Modification Response message including the delta DU configuration, and the CU 172 sends 431D to the MN 104 an SN Modification Request Acknowledge message including the delta DU configuration. The DU 174 may include the delta DU configuration rather than a full DU configuration based on the UE Context Modification Request message not including a full configuration request.

The MN 104 transmits the delta DU configuration to the UE 102 during an MR-DC resume procedure 461D. The MR-DC resume procedure 461D may be generally similar to the MR-DC resume procedure 361D, with the exception that the UE 102 performs a random access procedure with the SN 106 by exchanging messages with the DU 174 and, after successfully performing the random access procedure, the UE 102 communicates in DC with the MN 104 (with the DU 174 in accordance with the delta DU configuration and a portion of the first DU configuration, and with the CU 172 via the DU 174).

Referring next to FIG. 4E, in a scenario 400E, the base station 104 operates as an MN, and the base station 106 operates as an SN that includes a CU 172 and a DU 174. The scenario 400E is generally similar to the scenario 400D, but with the CU 172, rather than the MN 104, determining that the UE 102 does not release the first DU configuration. The scenario 400E is also generally similar to the scenario 300E, but with the SN 106 including the CU 172 and the DU 174.

The events 451E, 420E, and 422E may be similar to the events 451D, 420D, and 422D. The MN 104 sends 429D to the CU 172 an SN Modification Request message including an indication to resume lower layers for communicating with the UE 102. Thereafter, the CU 172 determines 430E that the UE 102 does not release the first DU configuration before resuming radio connectivity. The CU 172 can make the determination 430E based on a UE capability, such as a UE capability received from the DU 174, another base station, the core network 110, or the UE 102. The events 486E, 488E, 431E, and 461E may be similar to the events 486D, 488D, 431D, and 461D, respectively.

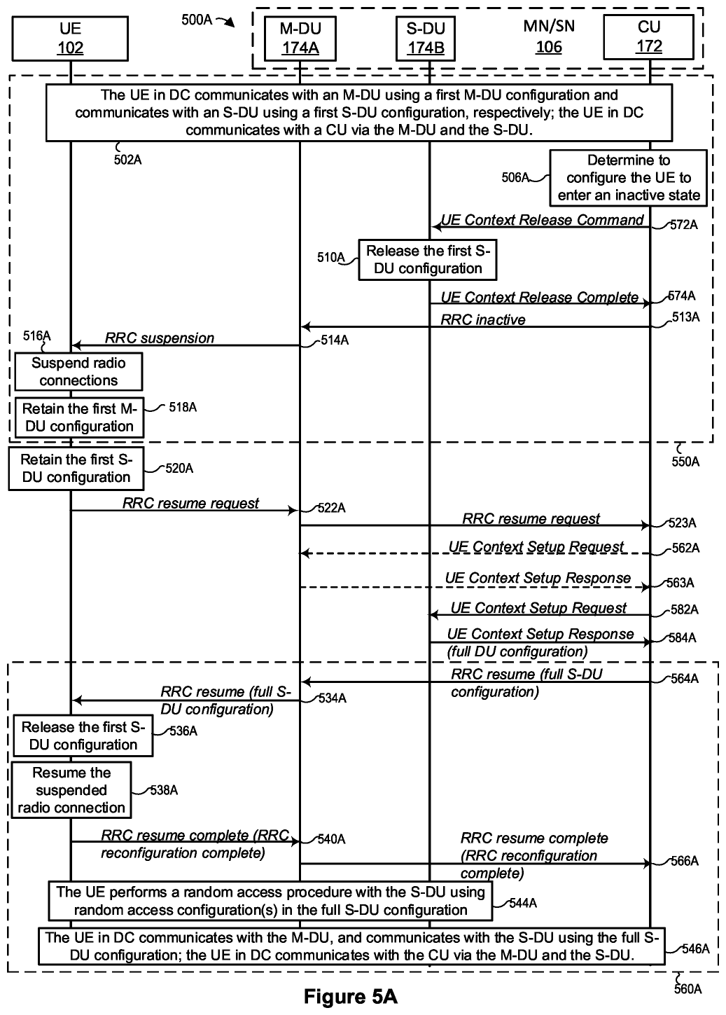

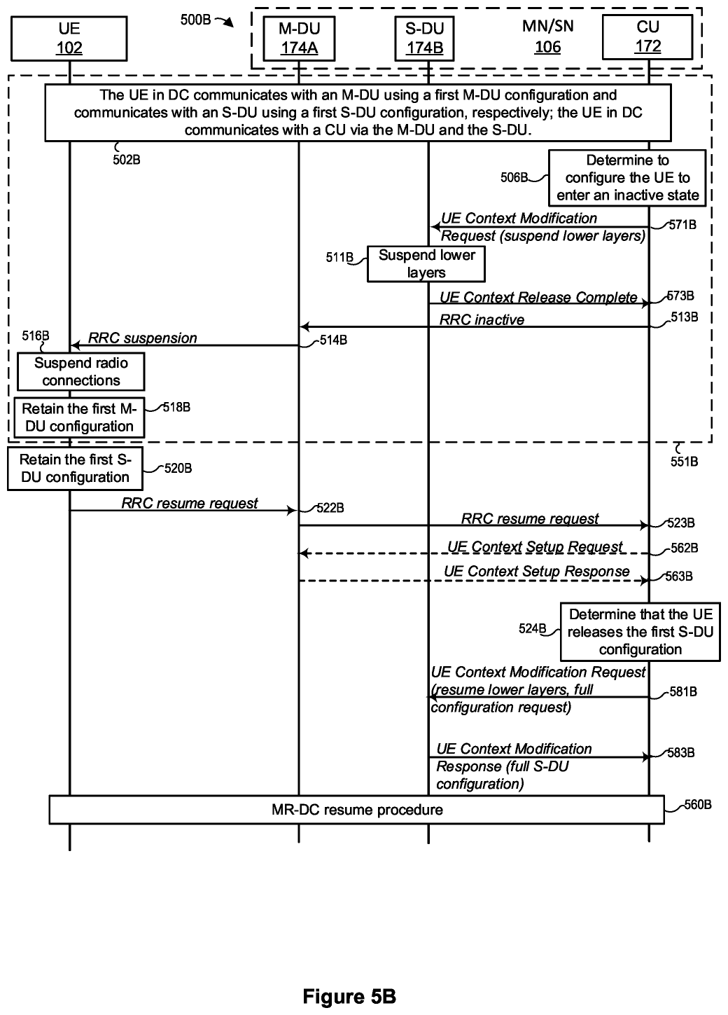

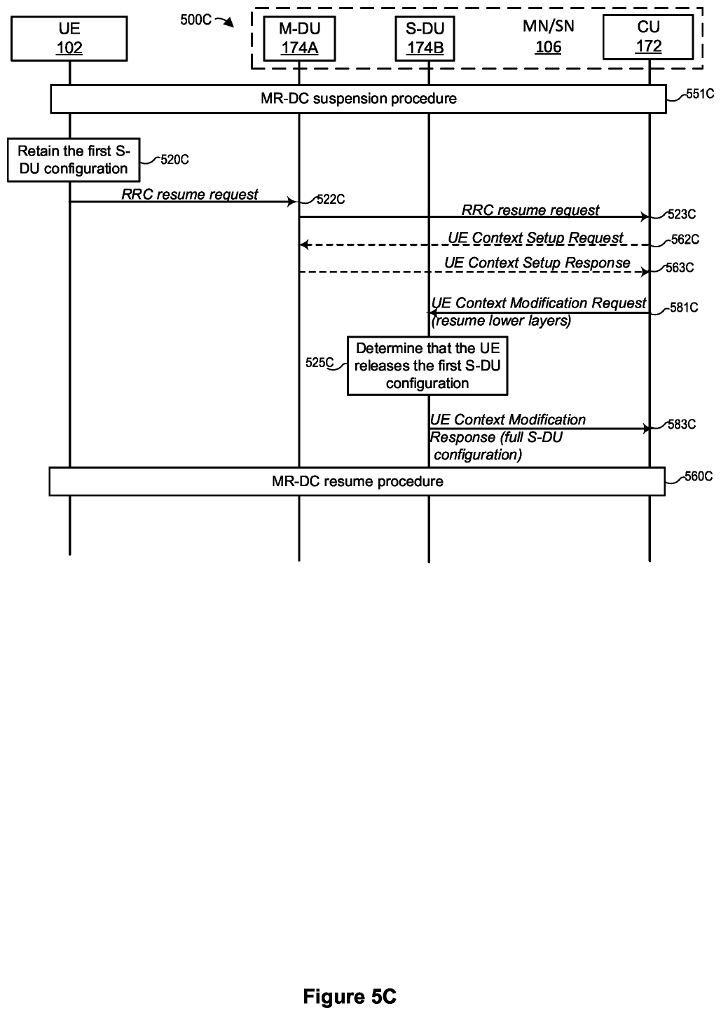

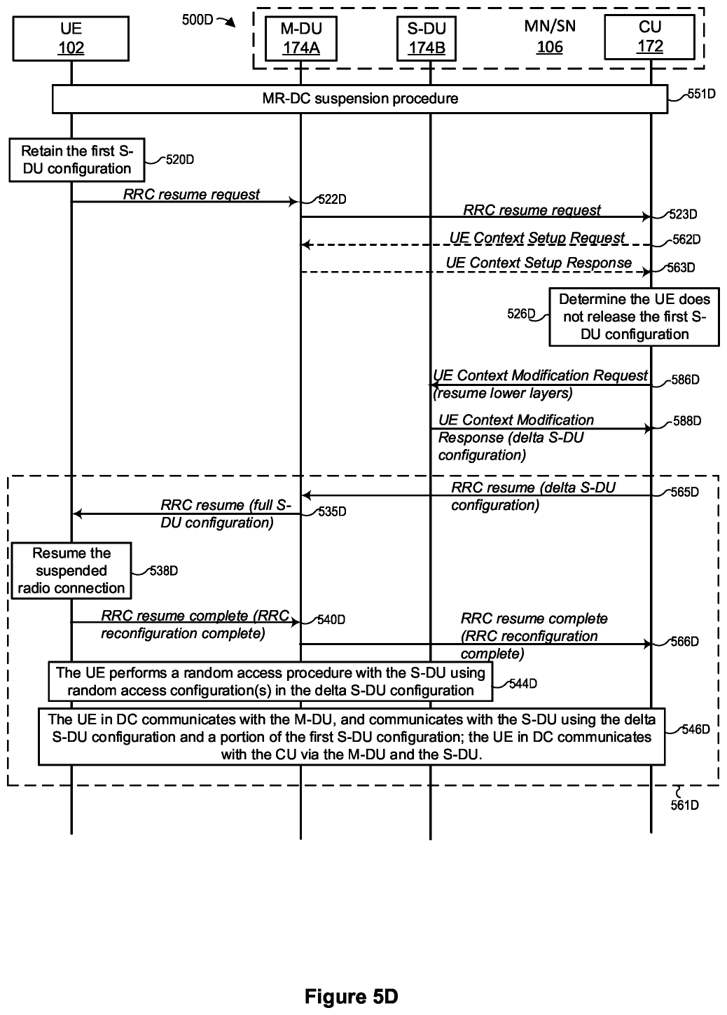

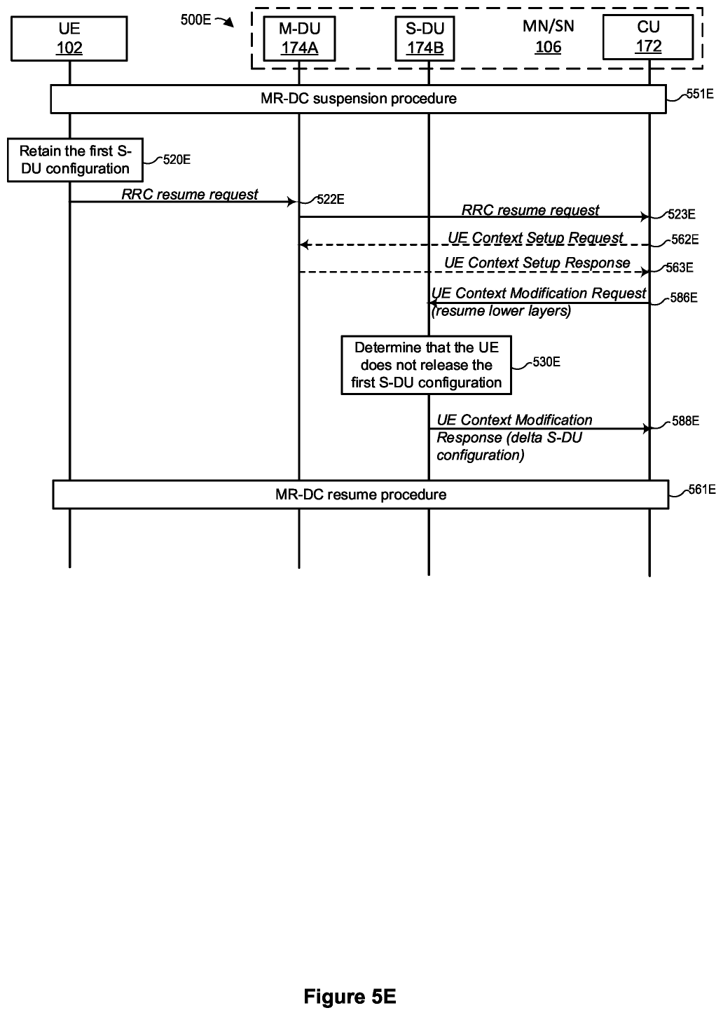

FIGS. 5A-5E are example message sequences similar to FIGS. 4A-4E, but where portions of a single base station serve as the MN and the SN. Accordingly, events in the scenarios depicted in FIGS. 5A-5E similar to those discussed with respect to FIGS. 4A-4E are labeled with similar reference numbers. With the exception of the differences shown in the figures and the differences described below, any of the alternative implementations discussed above with respect to the scenarios 400A-E (e.g., for messaging and processing) may apply to the scenarios 500A-E, respectively. As one example difference, the MN and the SN in FIGS. 5A-5E do not need to exchange SN Modification Request and SN Modification Request Acknowledge messages, as in FIGS. 3A-4E.

Turning to FIG. 5A, in a scenario 500A, the base station 106 operates as both an MN and an SN, with the MN including a CU (e.g., the CU 172) and a first DU (e.g., a DU 174A of the one or more DUs 174, referred to herein as an M-DU 174A) of the base station 106, and the SN including the same CU and a second, different DU (e.g., a DU 174B of the one or more DUs 174, referred to herein as an S-DU 174B) of the base station 106. The scenario 500A is generally similar to the scenario 400A, with the exception that the single base station 106 includes both the MN and the SN.

Initially, the UE 102 communicates 502A in DC with the M-DU 174A using a first M-DU configuration, with the S-DU 174B using a first S-DU configuration, and with the CU 172 via the M-DU 174A and the S-DU 174B. Similar to the events 306A and 406A, the CU 172 determines 506A to configure the UE 102 to enter an inactive state or an idle state with a suspended radio connection. In response to the determination 506A, the CU 172 sends 572A to the S-DU 174B a UE Context Release Command message, which causes the S-DU 174B to release lower layers (e.g., PHY 202A/202B, MAC 204A/204B, and/or RLC 206A/206B) for communicating with the UE 102. These resources can include software, firmware, memories, and/or processing power that the S-DU 174B uses to implement functions of the PHY 202A/202B, MAC 204A/204B, and/or RLC 206A/206B layers for communicating with the UE. For example, the S-DU 174B can release processing power from the ASIC, DSP, and/or CPU of the S-DU 174B allocated to communicate with the UE 102. In the scenario 500A, the S-DU 174B also or instead releases 510A the first S-DU configuration in response to the UE Context Release Command message. The S-DU 174B sends 574A to the CU 172 a UE Context Release Complete message in response to the UE Context Release Command message.

In some implementations, in response to the determination 506A, the CU 172 sends to the M-DU 174A a UE Context Release Command message, which causes the M-DU 174A to release lower layers (e.g., PHY 202A/202B, MAC 204A/204B, and/or RLC 206A/206B) for communicating with the UE 102. These resources can include software, firmware, memories, and/or processing power that the M-DU 174A uses to implement functions of the PHY 202A/202B, MAC 204A/204B, and/or RLC 206A/206B layers for communicating with the UE. For example, the M-DU 174A can release processing power from the ASIC, DSP, and/or CPU of the M-DU 174A allocated to communicate with the UE 102. In the scenario 500A, the M-DU 174A also or instead releases the first M-DU configuration in response to the UE Context Release Command message. The M-DU 174A sends to the CU 172 a UE Context Release Complete message in response to the UE Context Release Command message.

Thereafter, the CU 172 sends 513A an RRC inactive message to the M-DU 174A, and the M-DU 174A in turn sends 514A an RRC suspension message to the UE 102. The events 516A and 518A may be similar to the events 416A and 418A, with the UE 102 suspending 516A radio connections with the MN and the SN, and retaining 518A the first M-DU configuration. The events 502A, 506A, 572A, 510A, 574A, 513A, 514A, 516A, and 518A are collectively referred to in FIG. 5A as an MR-DC suspension procedure 550A. The event 520A may be similar to the event 420A, with the UE 102 retaining or releasing the first S-DU configuration.

At a later time, the UE 102 sends 522A an RRC resume request message to the M-DU 174A, which in turn sends 523A the RRC resume request message to the CU 172. In some implementations, the CU 172 sends 562A a UE Context Setup Request message to the M-DU 174A, and the M-DU 174A responds by sending 563A a UE Context Setup Response message to the CU 172.

The events 582A and 584A may be similar to the events 482A and 484A, with the CU 172 receiving 584A a full S-DU configuration from the S-DU 174B that the UE 102 is to use to communicate with the S-DU 174B. The CU 172 transmits 564A to the M-DU 174A an RRC resume message including the full S-DU configuration, and the M-DU 174A transmits 534A the RRC resume message to the UE 102. In response to the RRC resume message, the UE 102 releases 536A the first S-DU configuration, resumes 538A the suspended radio connection with the M-DU 174A, and transitions to the connected state. The UE 102 can transmit 540A to the M-DU 174A an RRC resume complete message including an RRC reconfiguration complete message in response to the RRC resume message. After receiving 540A the RRC resume complete message, the M-DU 174A can send 566A the RRC resume complete message to the CU 172. The events 534A, 536A, 538A, and 540A may be similar to the events 334A, 336A, 338A, and 340A, respectively.

After receiving 534A the full S-DU configuration, the UE 102 can perform 544A a random access procedure with the S-DU 174B using one or more random access configurations in the full S-DU configuration, similar to the random access procedure 344A. After successfully performing the random access procedure, the UE 102 communicates 546A in DC with the M-DU 174A, with the S-DU 174B in accordance with the full S-DU configuration, and with the CU 172 via the M-DU 174A and the S-DU 174B. The events 564A, 534A, 536A, 538A, 540A, 566A, 544A, and 546A are collectively referred in FIG. 5A as an MR-DC resume procedure 560A.

Referring next to FIG. 5B, a scenario 500B involves another MR-DC resumption procedure in which the base station 106 operates as both an MN and an SN, with the MN including the CU 172 and a first DU 174A and the SN including the CU 172 and a second DU 174B. The scenario 500B is generally similar to the scenario 500A, but with the CU 172 determining that the UE 102 releases the first S-DU configuration. The scenario 500B is also generally similar to the scenario 400B, with the exception that the base station 106 includes both the MN and the SN.

Events 502B and 506B may be similar to the events 502A and 506A, respectively. Thereafter, the CU 172 sends 571B to the S-DU 174B a UE Context Modification Request message including an indication to suspend lower layers for communicating with the UE 102. In response, the S-DU 174B suspends 511B lower layers, similar to event 411B. After suspending lower layers, the S-DU 174B transmits 573B to the CU 172 a UE Context Release Complete message.

Events 513B, 514B, 516B, and 518B may be similar to the events 513A, 514A, 516A, and 518A, respectively. The events 502B, 506B, 571B, 511B, 573B, 513B, 514B, 516B, and 518B are collectively referred to herein as an MR-DC suspension procedure 551B.

The events 520B, 522B, 523B, 562B, and 563B may be similar to the events 520A, 522A, 523A, 562A, and 563A, respectively. Thereafter, the CU 172 determines 524B that the UE 102 releases the first DU configuration before resuming radio connectivity, similar to the event 424B. In response to the determination 524B, the CU 172 sends 581B to the S-DU 174B a UE Context Modification Request message including an indication to resume lower layers and including a full configuration request. The S-DU 174B obtains (e.g., generates) a full S-DU configuration in response, and transmits 583B to the CU 172 a UE Context Modification Response message including the full S-DU configuration. The CU 172 can transmit the full S-DU configuration to the UE 102, via the M-DU 174B, during an MR-DC resume procedure 560B, which may be similar to the MR-DC resume procedure 560A.

Referring next to FIG. 5C, a scenario 500C involves another MR-DC resumption procedure in which the base station 106 operates as both an MN and an SN, with the MN including the CU 172 and the M-DU 174A and the SN including the CU 172 and the S-DU 174B. The scenario 500C is generally similar to the scenario 500B, but with the S-DU 174B determining 525C that the UE 102 releases the first S-DU configuration rather than the CU 172. The scenario 500C is also generally similar to the scenario 400C, but with the base station 106 including the MN and the SN.

The events 551C, 520C, 522C, 523C, 562C, and 563C may be similar to the events 551B, 520B, 522B, 523B, 562B, and 563B, respectively. Thereafter, the CU 172 sends 581C a UE Context Modification Request message including an indication to resume lower layers. The S-DU 174B determines 525C that the UE 102 releases the first S-DU configuration before resuming radio connectivity, similar to the determination 425C. In response, the S-DU 174B obtains, or generates, a full S-DU configuration. The S-DU 174B sends 583C to the CU 172 a UE Context Modification Response message including the full S-DU configuration. The CU 172 transmits the full S-DU configuration to the UE 102, via the M-DU 174A, during an MR-DC resume procedure 560C, which may be similar to the MR-DC resume procedure 560B.

Referring next to FIG. 5D, a scenario 500D involves another MR-DC resumption procedure in which the base station 106 operates as both an MN and an SN, with the MN including the CU 172 and the M-DU 174A and the SN including the CU 172 and the S-DU 174B. The scenario 500D is generally similar to the scenario 500B, but with the CU 172 determining that the UE 102 does not release the first S-DU configuration. The scenario 500D is also generally similar to the scenario 400D, but with the base station 106 including the MN and the SN.

Events 551D, 520D, 522D, 523D, and 563D may be similar to the events 551B, 520B, 522B, 523B, 562B, and 563B, respectively. Thereafter, the CU 172 determines 526D that the UE 102 does not release the first S-DU configuration before resuming radio connectivity, similar to the determination 426D. In response to the determination 526D, the CU 172 sends 586D to the S-DU 174B a UE Context Modification Request message including an indication to resume lower layers. In response to the indication, the S-DU 174 obtains, or generates, a delta S-DU configuration for the UE 102 and transmits 588D to the CU 172 a UE Context Modification Response message including the delta S-DU configuration.

Events 565D and 535D may be similar to the events 564A and 534A, respectively, with the exception that the DU configuration is a delta S-DU configuration. Events 538D, 540D, and 566D may be generally similar to the events 538A, 540A, and 566D, respectively. Event 544D may be generally similar to the event 544A, with the exception that the UE 102 performs a random access procedure with the S-DU 174B using random access configurations in the delta S-DU configuration (or in a portion of the first DS-U configuration not augmented by the delta SN configuration). The UE 102 communicates 546D in DC with the M-DU 174A, with the S-DU 174B in accordance with the delta S-DU configuration and the portion of the first DU configuration not augmented by the delta SN configuration, and with the CU 172 via the M-DU 174A and the S-DU 174B. The events 565D, 535D, 538D, 540D, 566D, 544D, and 546D are collectively referred to herein as an MR-DC resume procedure 561D.

Referring next to FIG. 5E, a scenario 500E involves another MR-DC resumption procedure in which the base station 106 operates as both an MN and an SN, with the MN including the CU 172 and the M-DU 174A and the SN including the CU 172 and the S-DU 174B. The scenario 500E is generally similar to the scenario 500D, but with the S-DU 174B determining that the UE 102 does not release the first S-DU configuration rather than the CU 172. The scenario 500E is also generally similar to the scenario 400E, but with the base station 106 including the MN and the SN.

Events 551E, 520E, 522E, 523E, 562E, 563E, and 586E may be similar to the events 551D, 520D, 522D, 523D, 562D, 563D, and 586D, respectively. The S-DU 174B, rather than the CU 172 as in scenario 500D, determines 530E that the UE 102 does not release the first S-DU configuration. In response, the S-DU 174B sends 588E to the CU 172 a UE Context Modification Response message including a delta S-DU configuration. The CU 172 sends the delta S-DU configuration to the UE 102, via the M-DU 174A, during an MR-DC resume procedure 561E, which may be similar to the MR-DC resume procedure 561D.

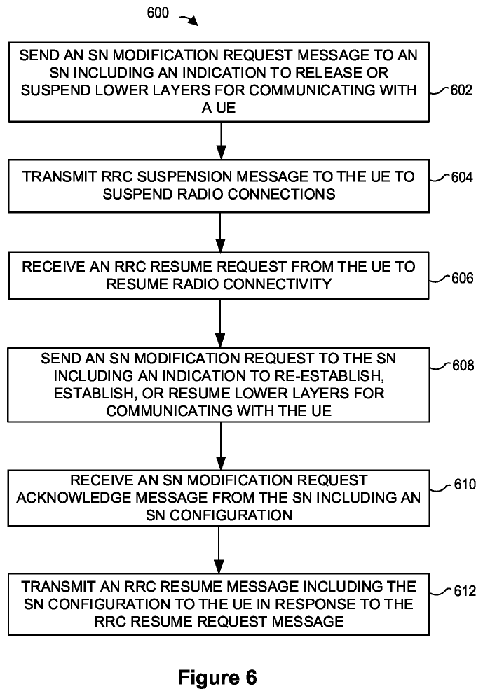

FIGS. 6-22 are flow diagrams depicting methods that RAN nodes or a UE (such as the UE 102) can perform for resuming MR-DC between the UE 102 and the RAN 105.

FIG. 6 is a flow diagram depicting a method 600 for resuming MR-DC with a UE (e.g., the UE 102), which may be implemented by an MN (e.g., the MN 104) of this disclosure. At block 602, the MN sends an SN Modification Request message to an SN (e.g., to the SN 106 or to a node of SN 106, such as the CU 172) including an indication to release or suspend lower layers for communicating with the UE (e.g., event 308A, 309B, 408A, or 409B, or similar events within procedures 351C, 351D, 351E, 451C, 451D, or 451E). At block 604, the MN transmits an RRC suspension message to the UE to suspend radio connections between the UE and the MN and the SN (e.g., event 314A, 314B, 414A, or 414B, or similar events within procedures 351C, 351D, 351E, 451C, 451D, or 451E). Next, at block 606, the MN receives an RRC resume request message from the UE to resume radio connectivity with the RAN (e.g., event 322A-E or 422A-E).

In response to the RRC resume request, the MN sends, at block 608, an SN Modification Request message to the SN including an indication to re-establish, establish, or resume lower layers for communicating with the UE (e.g., 328A, 327B, 329C, 329D, 329E, 428A, 427B, 429C, 429D, or 429E). At block 610, the MN receives an SN Modification Request Acknowledge message from the SN including an SN configuration, which may be a full SN configuration or a delta SN configuration (e.g., event 332A, 332B, 33C, 331D, 331E, 432A, 432B, 433C, 431D, or 431E). Next, at block 612, the MN transmits an RRC resume message to the UE including the full SN configuration in response to the RRC resume request message (e.g., event 334A or 335D, or similar events within procedures 360B, 360C, or 361E).

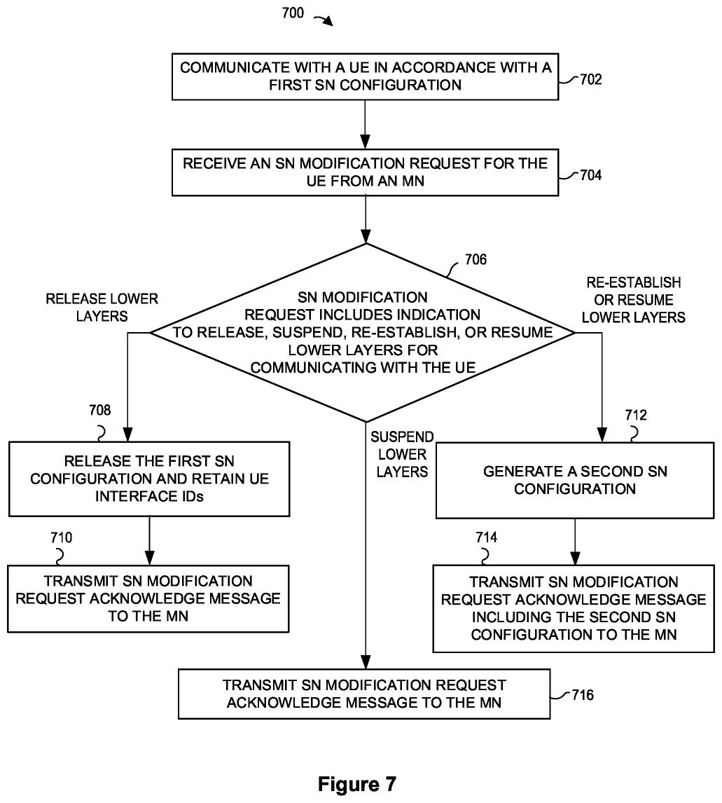

FIG. 7 is a flow diagram depicting a method 700 for responding to an SN Modification Request message received from an MN, which may be implemented by an SN (e.g., the SN 106 and/or one or more nodes the SN 106, such as the CU 172 and/or the DU 174). At block 702, the SN communicates with a UE (e.g., the UE 102) in accordance with a first SN configuration (e.g., event 302A, 302B, 402A, or 402B). In implementations in which the SN includes a CU and a DU, the SN may communicate with the UE via the DU and with an MN (e.g., the MN 104) via the CU, in which case the first SN configuration may be a first DU configuration.

At some later time, the SN receives, at block 704, an SN Modification Request message related to the UE 102 from the MN. Next, at block 706, the SN determines whether the SN Modification Request message includes an indication to release, suspend, re-establish, or resume lower layers for communicating with the UE.

If the SN Modification Request message includes an indication to release lower layers (e.g., event 308A or 408A), then the flow proceeds to block 708. At block 708, the SN releases the first SN configuration and retains UE interface IDs (e.g., event 310A or 410A). At block 710, the SN transmits an SN Modification Request Acknowledge message to the MN (e.g., event 312A or 412A).

If the SN Modification Request message includes an indication to re-establish or to resume lower layers (e.g., event 328A, 327B, 329C, 329D, 329E, 428A, 429C, 429D, or 429E), then the flow proceeds to block 712. The SN Modification Request message can include such an indication if, for example, between blocks 702 and 704, the SN received an earlier SN Modification Request including an indication to release or suspend lower layers. At block 712, the SN generates a second SN configuration, which may be a full configuration or a delta configuration, and may or may not be a DU configuration depending on the implementation. At block 714, the SN transmits an SN Modification Request Acknowledge message to the MN including the second SN configuration (e.g., event 332A, 332B, 333C, 331D, 331E, 432A, 432B, 433C, 431D, or 431E).

If the SN Modification Request message includes an indication to suspend lower layers (e.g., event 309B or 409B, or similar events within procedures 351C, 351D, 351E, 451C, 451D, or 451E), then the flow proceeds to block 716. At block 716, the SN transmits an SN Modification Request Acknowledge message to the MN (e.g., event 312B or 412B, or similar events within procedures 351C, 351D, 351E, 451C, 451D, or 451E).

In some implementations, the method 700 omits either the path with blocks 708/710 or the path with block 716. In an implementation where the SN Modification Request message cannot include an indication to suspend the lower layers, for example, the SN may only determine at block 706 whether to proceed to block 708 or block 712.

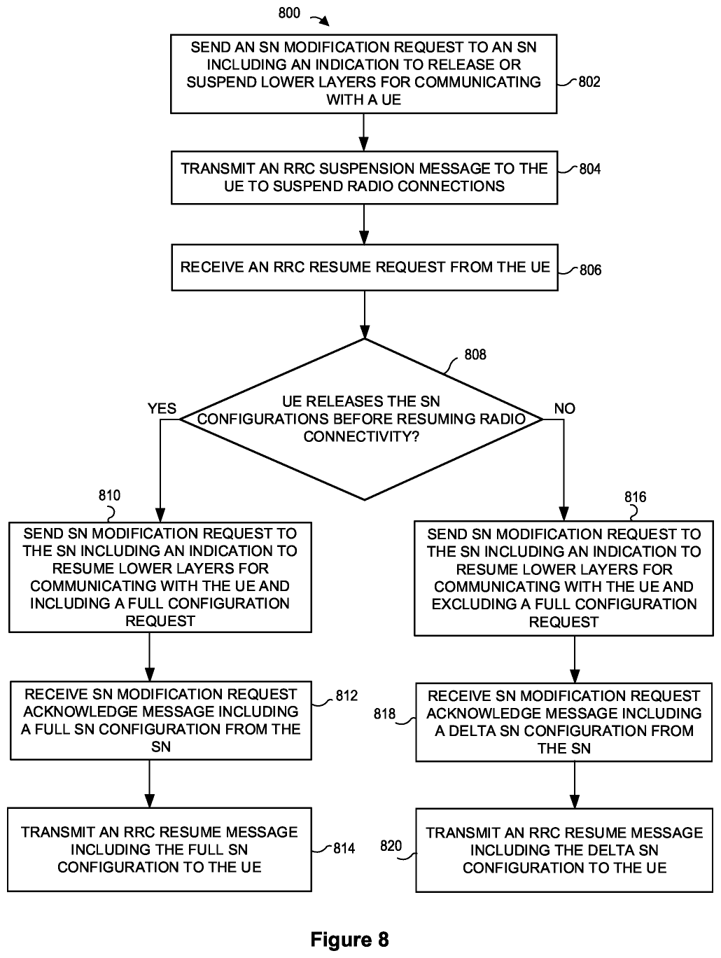

FIG. 8 is a flow diagram depicting a method 800 for facilitating resumption of MR-DC using a full or delta SN configuration, which may be implemented by an MN (e.g., the MN 104). At block 802, the MN sends an SN Modification Request message to an SN (e.g., the SN 106, or a node of the SN 106, such as the CU 172) including an indication to release or suspend lower layers for communicating with a UE (e.g., the UE 102) (e.g., event 308A, 309B, 408A, or 409B, or similar events within procedures 351C, 351D, 351E, 451C, 451D, or 451E). At block 804, the MN transmits an RRC suspension message to the UE to suspend radio connections between the UE and the MN and SN (e.g., event 314A, 314B, 414A, or 414B, or similar events within procedures 351C, 351D, 351E, 451C, 451D, or 451E). At some later time, at block 806, the MN receives an RRC resume request message from the UE to resume radio connectivity with the RAN (e.g., event 322A-E or 422A-E).

At block 808, the MN determines whether the UE releases configurations for communicating with the SN (or a node of the SN, such as the DU 174) before resuming radio connectivity with the RAN. If the MN determines that the UE releases SN configurations before resuming radio connectivity (e.g., event 324B or 424B), then the flow proceeds to block 810. If the MN determines that the UE does not release SN configurations before resuming radio connectivity (e.g., event 326D or 426D), then the flow proceeds to block 816. The MN may make the determination at block 808 based on a UE capability of the UE, which the MN may receive from a core network (e.g., the core network 110), another base station, or the UE.

If the flow proceeds to block 810, then the MN sends an SN Modification Request message to the SN including an indication to resume lower layers for communicating with the UE and including a full configuration request (e.g., event 327B or 427B). Thereafter, the MN receives, at block 812, an SN Modification Request Acknowledge message including a full SN configuration, which may be a full DU configuration, from the SN (e.g., event 332B or 432B). Next, at block 814, the MN transmits an RRC resume message to the UE including the full SN configuration (e.g., an event within procedure 360B or 460B).

If the flow proceeds to block 816, then the MN sends an SN Modification Request message to the SN including an indication to resume lower layers for communicating with the UE and excluding a full configuration request (e.g., event 329D or 429D). Thereafter, the MN receives, at block 818, an SN Modification Request Acknowledge message including a delta SN configuration, which may be a delta DU configuration, from the SN (e.g., event 331D or 431D). Next, at block 820, the MN transmits an RRC resume message to the UE including the delta SN configuration in response to the RRC resume request message (e.g., event 335D or an event during the procedure 461D).

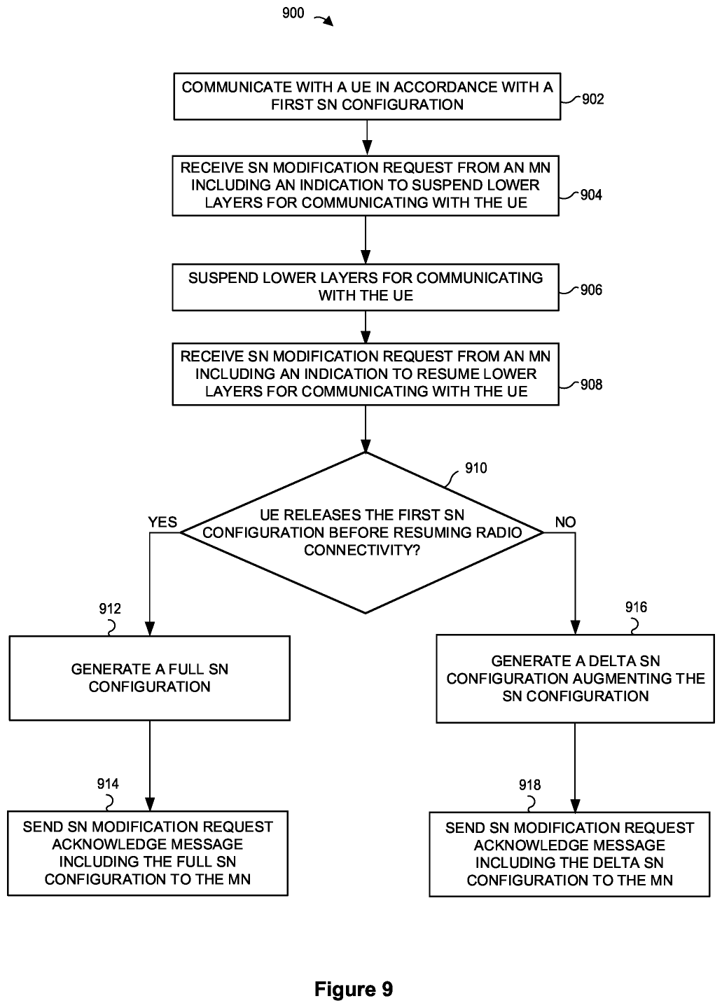

FIG. 9 is a flow diagram of a method 900 for facilitating resumption of MR-DC using a full or delta SN configuration, which may be implemented by an SN (e.g., the SN 106, or one or more nodes of the SN 106, such as the DU 174 and/or the CU 172). At block 902, the SN communicates with a UE (e.g., the UE 102) in accordance with a first SN configuration, which may be a first DU configuration (e.g., event 302A, 302B, 402A, or 402B, or similar events within procedures 351C, 351D, 351E, 451C, 451D, or 451E). At block 904, the SN receives an SN Modification Request message from an MN (e.g., the MN 104) including an indication to suspend lower layers for communicating with the UE (e.g., event 309B or 409B, or similar events within procedures 351C, 351D, 351E, 451C, 451D, or 451E). At block 906, in response to the indication to suspend lower layers, the SN suspends lower layers for communicating with the UE (e.g., event 311B or 411B, or similar events within procedures 351C, 351D, 351E, 451C, 451D, or 451E).

At a later time, at block 908, the SN receives an SN Modification Request from the MN including an indication to resume lower layers for communicating with the UE (e.g., event 329C, 329E, 429C, or 429E). At block 910, the SN determines whether the UE releases configurations for communicating with the SN (or a node of the SN, such as the DU 174) before resuming radio connectivity with the RAN. If the SN determines that the UE releases SN configurations before resuming radio connectivity (e.g., event 325C or 425C), then the flow proceeds to block 912. If the SN determines that the UE does not release SN configurations before resuming radio connectivity (e.g., event 330E or 430E), then the flow proceeds to block 916. The SN may make the determination at block 910 based on a UE capability of the UE, which the SN may receive from a core network (e.g., the core network 110), another base station, or the UE.

If the flow proceeds to block 912, then the SN generates a full SN configuration, which may be a full DU configuration. At block 914, the SN sends an SN Modification Request Acknowledge message including the full SN configuration to the MN (e.g., event 333C or 433C).

If the flow proceeds to block 916, then the SN generates a delta SN configuration, which may be a delta DU configuration. At block 918, the SN sends an SN Modification Request Acknowledge message including the delta SN configuration to the MN (e.g., event 331E or 431E).

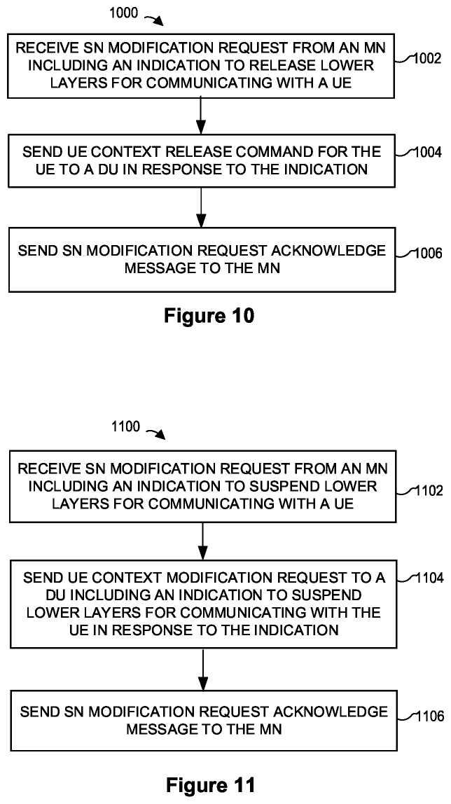

FIG. 10 is a flow diagram of a method 1000 for responding to an SN Modification Request message received from an MN and including an indication to release lower layers for a UE, which can be implemented by a CU of an SN (e.g., the CU 172 of the SN 106). At block 1002, the CU receives an SN Modification Request message from an MN (e.g., the MN 104) including an indication to release lower layers for communicating with a UE (e.g., the UE 102) (e.g., event 408A). At block 1004, the CU sends a UE Context Release Command for the UE to a DU (e.g., the DU 174) in response to the indication to release lower layers (e.g., event 472A). At block 1006, the CU sends an SN Modification Request Acknowledge message to the MN (e.g., event 412A).

FIG. 11 is a flow diagram of a method 1100 for responding to an SN Modification Request message received from an MN and including an indication to suspend lower layers for a UE, which can be implemented by a CU of an SN (e.g., the CU 172 of the SN 106). At block 1102, the CU receives an SN Modification Request message from an MN (e.g., the MN 104) including an indication to suspend lower layers for communicating with a UE (e.g., the UE 102) (e.g., event 409B, or similar events within procedures 451C, 451D, or 451E). At block 1104, the CU sends a UE Context Modification Request for the UE to a DU (e.g., the DU 174) in response to the indication to suspend lower layers, the UE Context Modification Request including an indication to suspend lower layers for communicating with the UE (e.g., event 471B, or similar events within procedures 451C, 451D, or 451E). At block 1106, the CU sends an SN Modification Request Acknowledge message to the MN (e.g., event 412B, or similar events within procedures 451C, 451D, or 451E).

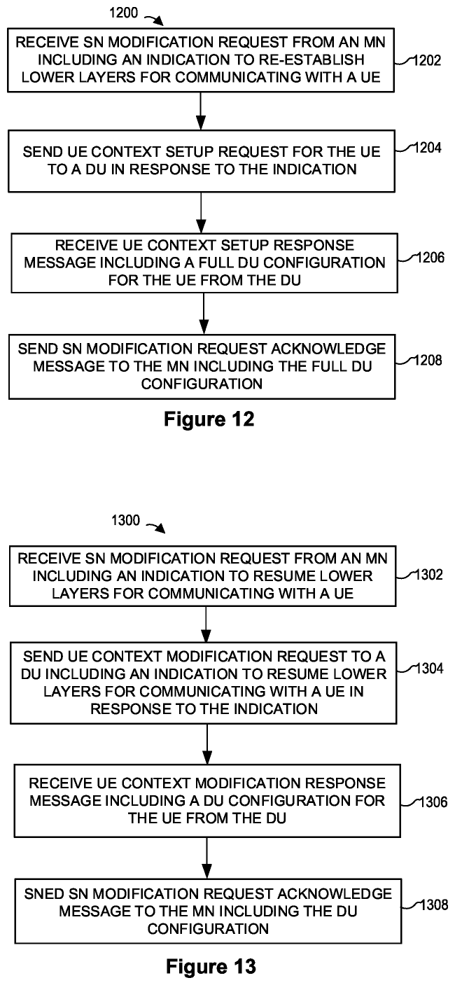

FIG. 12 is a flow diagram of a method 1200 for responding to an SN Modification Request message received from an MN and including an indication to re-establish lower layers for a UE, which can be implemented by a CU of an SN (e.g., the CU 172 of the SN 106). At block 1202, the CU receives an SN Modification Request message from an MN (e.g., the MN 104) including an indication to re-establish lower layers for communicating with a UE (e.g., the UE 102) (e.g., event 428A). At block 1204, the CU sends a UE Context Setup Request message for the UE to a DU (e.g., the DU 174) in response to the indication to re-establish lower layers (e.g., event 482A). At block 1206, the CU receives a UE Context Setup Response message including a full DU configuration for the UE from the DU (e.g., event 484A). At block 1208, the CU sends an SN Modification Request Acknowledge message to the MN including the full DU configuration (e.g., event 432A).

FIG. 13 is a flow diagram of a method 1300 for responding to an SN Modification Request message received from an MN and including an indication to resume lower layers for a UE, which can be implemented by a CU of an SN (e.g., the CU 172 of the SN 106). At block 1302, the CU receives an SN Modification Request message from an MN (e.g., the MN 104) including an indication to resume lower layers for communicating with a UE (e.g., the UE 102) (e.g., event 427B, 429C, 429D, or 429E). At block 1304, the CU sends a UE Context Modification Request message for the UE to a DU (e.g., the DU 174) in response to the indication to resume lower layers, the UE Context Modification Request including an indication to resume lower layers for communicating with the UE (e.g., event 481B, 481C, 486D, 486E). At block 1306, the CU receives a UE Context Modification Response message including a DU configuration, which may be a full or a delta DU configuration, for the UE from the DU (e.g., event 483B, 483C, 488D, 488E). At block 1308, the CU sends an SN Modification Request Acknowledge message to the MN including the DU configuration (e.g., event 432B, 433C, 431D, 431E).

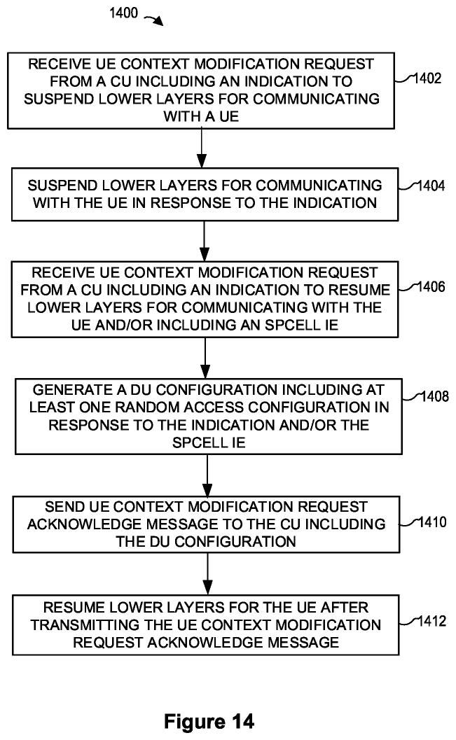

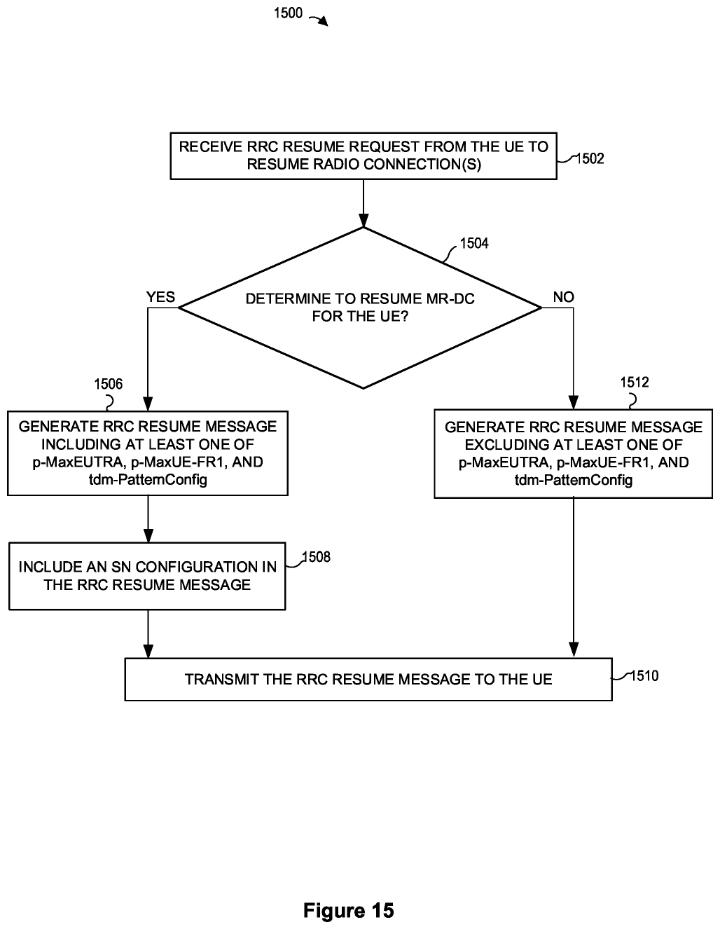

FIG. 14 is a flow diagram of a method 1400 for providing a DU configuration to a CU that a UE can use to resume MR-DC, which can be implemented by a DU of an SN (e.g., the DU 174 or S-DU 174B of the base station 106). At block 1402, the DU receives a UE Context Modification Request message from a CU (e.g., the CU 172 of the base station 106) including an indication to suspend lower layers for communicating with a UE (e.g., the UE 102) (e.g., event 471B or 571B, or similar events within procedures 451C, 451D, 451E, 551C, 551D, or 551E). At block 1404, the DU suspends lower layers for communicating with the UE in response to the indication to suspend lower layers (e.g., event 411B or 511B, or similar events within procedures 451C, 451D, 451E, 551C, 551D, or 551E). At block 1406, the DU receives a UE Context Modification Request message from the CU including an indication to resume lower layers for communicating with the UE and/or including an SpCell IE (e.g., event 481B, 481C, 486D, 486E, 581B, 581C, 586D, or 586E).

In response to the indication to resume lower layers and/or the SpCell IE, the DU, at block 1408, generates a DU configuration including at least one random access configuration. The DU configuration can be a full or a delta configuration. At block 1410, the DU sends a UE Context Modification Request Acknowledge message to the CU including the DU configuration (e.g., event 483B, 483C, 488D, 488E, 583B, 583C, 588D, or 588E). At block 1412, after the DU transmits the UE Context Modification Request Acknowledge message, the DU resumes lower layers for communicating with the UE.

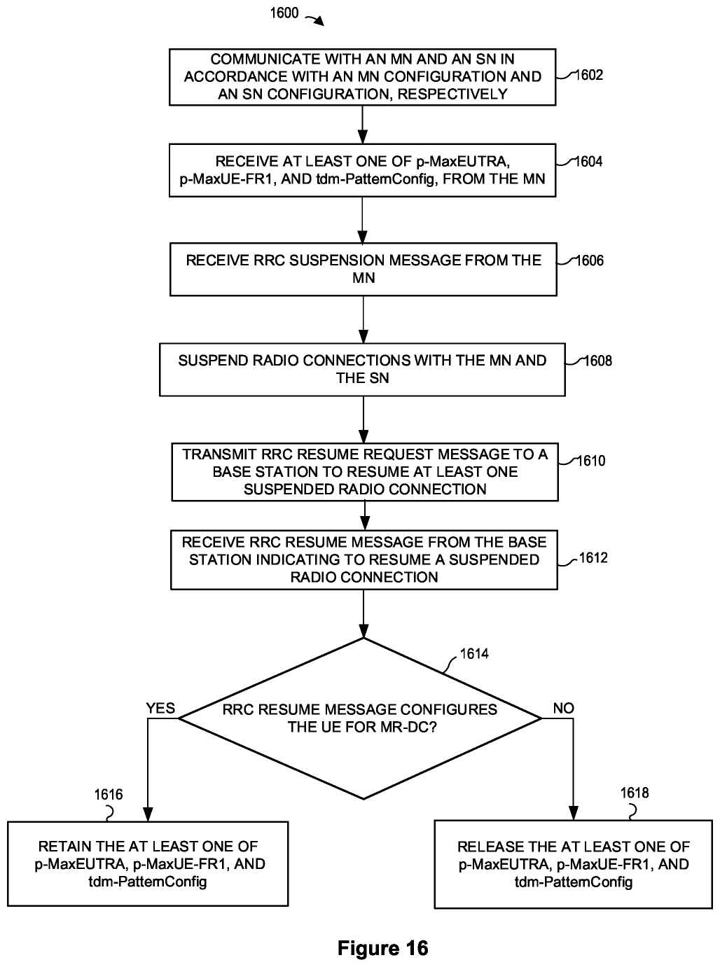

Turning to FIGS. 15-16, depending on the implementation and/or scenario, a UE (e.g., the UE 102) can receive configuration parameters from the RAN 105 in an RRC resume message, or can utilize retained configuration parameters after resuming MR-DC with the RAN 105.

For example, in some implementations, an MN (e.g., the MN 104) can include, in an RRC resume message (e.g., at event 334A, 335D, 534A, or 535D, or during procedures 360B, 360C, 361E, 460A, 460B, 460C, 461D, 461E, 560B, 560C, or 561E), one or more configuration parameters the UE can use to communicate with the MN and/or the SN (e.g., the SN 106). For example, one of the configuration parameters may indicate a maximum uplink power that the UE can use to transmit to the MN and/or the SN. The UE 102 limits the uplink transmissions toward the MN or the SN to not exceed the maximum uplink power indicated by the configuration parameter. In scenarios involving EUTRA/NR DC (EN-DC) or NG-RAN EUTRA/NR DC (NGEN-DC), the configuration parameter can be a p-MaxEUTRA field with a P-Max value. As another example, one of the configuration parameters may indicate a maximum uplink power that the UE can use to transmit to the MN and SN across serving cells across all cell groups (e.g., across both the master cell group and the secondary cell group) for specific frequency range(s). The UE restricts the uplink transmissions toward the MN and the SN across serving cells and across all cell groups for the specific frequency range(s) to not exceed the maximum uplink power indicated by the configuration parameter. In scenarios involving EN-DC or NGEN-DC, the configuration parameter can be a p-Max UE-FR1 field with a P-Max value. As a further example, one of the configuration parameters may indicate time instances in which the UE in MR-DC is allowed to transmit to the MN or the SN. The UE restricts uplink transmissions toward the MN or the SN in accordance with the indicated time instances. For example, the configuration parameter can be parameter indicating a time division multiplexing pattern, such as a tdm-PatternConfig-r15 field or a tdm-PatternConfig-r16 field in scenarios involving EN-DC or NGEN-DC.

FIG. 15 is a flow diagram of a method 1500 for providing power and/or timing parameters a UE is to use after resuming MR-DC, which can be implemented by an MN (e.g., the MN 104). At block 1502, the MN receives an RRC resume request message from a UE (e.g., the UE 102) to resume one or more radio connection(s) (e.g., event 322A-E, 422A-E, or 522A-E). At block 1504, the MN determines whether to resume MR-DC for the UE (i.e., whether to configure the UE to resume MR-DC).

If the MN determines to resume MR-DC for the UE, then the flow proceeds to block 1506. At block 1506, the MN generates an RRC resume message including at least one of p-MaxEUTRA, p-MaxUE-FR1, and tdm-PatternConfig. Next, at block 1508, the MN includes an SN configuration in the RRC resume message. From block 1508, the flow proceeds to block 1510.

If the MN determines not to resume MR-DC for the UE, then the flow proceeds to block 1512. At block 1512, the MN generates an RRC resume message excluding at least one of p-MaxEUTRA, p-MaxUE-FR1, and tdm-PatternConfig. From block 1512, the flow proceeds to block 1510. At block 1510, the MN transmits the RRC resume message to the UE (e.g., event 334A, 335D, 534A, or 535D, or during procedures 360B, 360C, 361E, 460A, 460B, 460C, 461D, 461E, 560B, 560C, or 561E).

FIG. 16 is a flow diagram of a method 1600 for retaining power and/or timing parameters a UE can use after resuming MR-DC, which can be implemented by a UE (e.g., the UE 102). Initially, at block 1602, the UE communicates in DC with an MN (e.g., the MN 104 or the CU 172 and M-DU 174A of the base station 106) and an SN (e.g., the SN 106 or the CU 172 and the S-DU 174B of the base station 106) in accordance with an MN configuration and an SN configuration, respectively (e.g., 302A, 302B, 402A, 402B, 502A, or 502B, or similar events within procedures 351C, 351D, 351E, 451C, 451D, 451E, 551C, 551D, or 551E). While communicating in DC with the MN (e.g., the MN 104) and the SN, the UE receives, at block 1604, at least one of p-MaxEUTRA, p-MaxUE-FR1, and tdm-PatternConfig, from the MN.

At block 1606, the UE receives an RRC suspension message from the MN (e.g., event 314A, 314B, 414A, 414B, 514A, or 514B, or similar events within procedures 351C, 351D, 351E, 451C, 451D, 451E, 551C, 551D, or 551E). At block 1608, the UE suspends its radio connections with the MN and the SN in response to the RRC suspension message (e.g., event 316A, 316B, 416A, 416B, 516A, or 516B, or similar events within procedures 351C, 351D, 351E, 451C, 451D, 451E, 551C, 551D, or 551E). At a later time, the UE at block 1610 transmits an RRC resume request message to a base station (e.g., any of the base stations 104 or 106) to resume a suspended radio connection (e.g., event 322A-E, 422A-E, or 522A-E). In response, at block 1612, the UE receives an RRC resume message indicating to resume a suspended radio connection (e.g., event 334A, 335D, 534A, or 535D, or similar events within procedures 360B, 360C, 361E, 460A, 460B, 460C, 461D, 461E, 560B, 560C, or 561E).

At block 1614, the UE determines whether the RRC resume message configures the UE for MR-DC. If the RRC resume message configures the UE for MR-DC, then the flow proceeds to block 1616, where the UE retains the least one of p-MaxEUTRA, p-MaxUE-FR1, and tdm-PatternConfig received previously. The UE can utilize the retained parameter after resuming MR-DC. If the RRC resume message does not configure the UE for MR-DC, then the flow proceeds to block 1618, where the UE releases the least one of p-MaxEUTRA, p-MaxUE-FR1, and tdm-PatternConfig received previously.

Further, a UE (e.g., the UE 102) communicating in DC with an MN and an SN using a first MN configuration and a first SN configuration, respectively, can receive an RRC resume message (e.g., 334A, 335D, 534A, or 535D, or similar events within procedures 360B, 360C, 361E, 460A, 460B, 460C, 461D, 461E, 560B, 560C, or 561E) including a second MN configuration and a second SN configuration. The UE can implement various techniques if the UE determines that the UE cannot apply the second MN configuration or the second SN configuration.

As one example, if the UE is able to comply with the second MN configuration but fails to comply with all or a portion of the second SN configuration, the UE can apply the second MN configuration to communicate with the MN but does not apply the second SN configuration. In response to the failure to comply with (at least a portion of) the second SN configuration, the UE can transmit an SCG failure information message (e.g., SCGFailureInformationNR message, SCGFailureInformation message, or SCGFailureInformationEUTRA message) indicating an SCG reconfiguration failure to the MN on an SRB (e.g., SRB1). In such a scenario, the UE can release the second SN configuration.

Alternatively, the UE can initiate an RRC connection reestablishment procedure with the MN in response to the failure to comply with (at least a portion of) the second SN configuration. In such a scenario, the UE can release the second SN configuration and the second MN configuration.

As another alternative, the UE can transition to the idle state without a suspended radio connection in response to the failure to comply with (a portion of) the second SN configuration. The UE does not inform the MN or the SN of the transition to the idle state. In response to the state transition to the idle state without a suspended radio connection, the UE can release a stored UE context, the first MN configuration, the second MN configuration, and the second SN configuration.

In other scenarios and implementations, if the UE fails to comply with (at least a portion of) the second MN configuration, irrespective of succeeding or failing to comply with (at least a portion of) the second SN configuration, the UE an initiate an RRC connection reestablishment procedure with the MN. In this case, the UE can release the second SN configuration and the second MN configuration.

Alternatively, the UE can transition to the idle state without a suspended radio connection in response to the failure to comply with (a portion of) the second MN configuration. The UE does not inform the MN and the SN of the transition to the idle state. The UE can release a stored UE context in response to the state transition to the idle state without a suspended radio connection. In response to the state transition to the idle state without a suspended radio connection, the UE can release the stored UE context, the first MN configuration, the second MN configuration, and the second SN configuration.

In response to initiating the RRC connection reestablishment procedure, the UE can transmit an RRC reestablishment request message to the MN. In response, the MN can transmit an RRC reestablishment message to the UE. The UE can transmit an RRC reestablishment complete message to the MN in response to the RRC reestablishment message.

In some implementations where the MN 104 is a gNB, the RRC reestablishment request message, the RRC reestablishment message, and the RRC reestablishment complete message can be an RRCReestablishmentRequest message, an RRCReestablishment message, and an RRCReestablishmentComplete message, respectively. In other implementations where the MN 104 is an eNB or ng-eNB, the RRC resume request message, the RRC resume message, and the RRC resume complete message can be an RRCConnectionReestablishmentRequest message, an RRCConnectionReestablishment message, and an RRCConnectionReestablishmentComplete message, respectively.

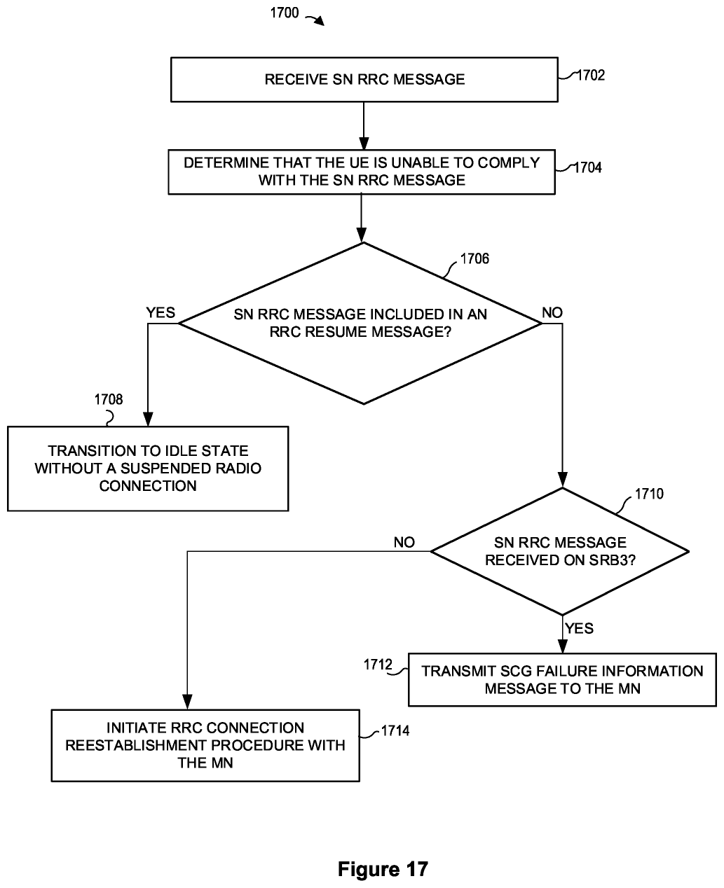

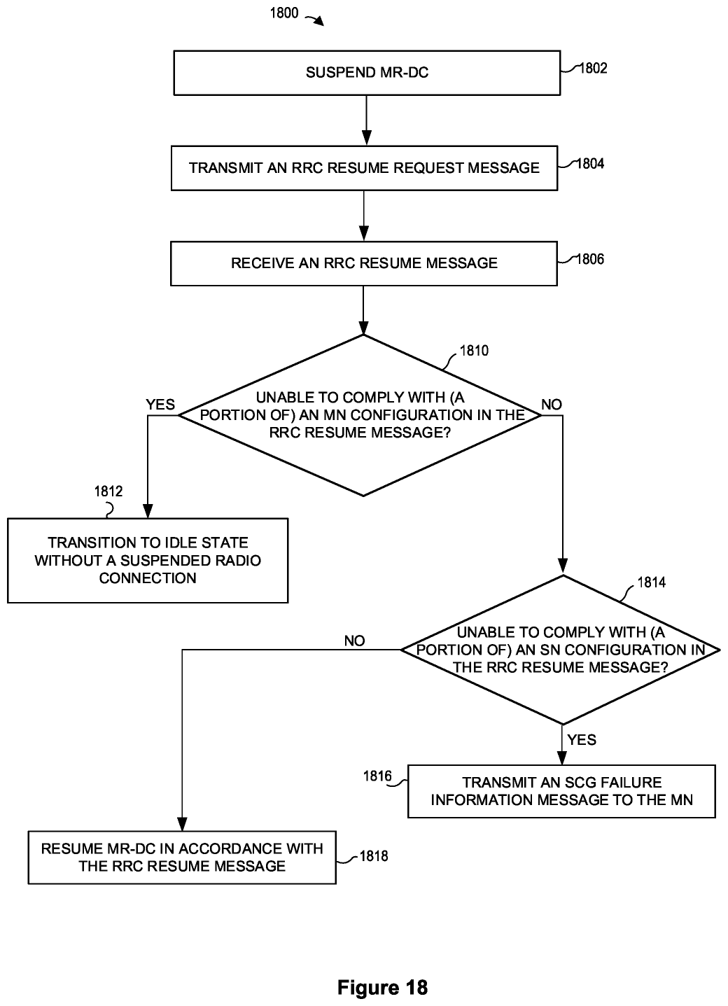

FIGS. 17-18 are flow diagrams illustrating example methods a UE (e.g., the UE 102) can implement in response to determining that the UE is unable to comply with an MN or SN configuration in an RRC resume message.

FIG. 17 is a flow diagram of a method 1700 a UE (e.g., the UE 102) can implement in response to determining that the UE is unable to apply an SN configuration in an RRC resume message. At block 1702, the UE receives an RRC message relating to an SN (e.g., the SN 106) (e.g., 334A, 335D, 534A, or 535D, or similar events within procedures 360B, 360C, 361E, 460A, 460B, 460C, 461D, 461E, 560B, 560C, or 561E). At block 1704, the UE determines that the UE is unable to comply with the RRC message. For example, the UE can determine that the UE is unable to comply with an SN configuration included in the RRC message. At block 1706, the UE determines whether the RRC message was included in an RRC resume message. If so, then the flow proceeds to block 1708, where the UE transitions to an idle state without a suspended radio connection. Otherwise, the flow proceeds to block 1710, where the UE determines whether the RRC message was received on SRB3. If the RRC message was received on SRB3, then the flow proceeds to block 1712, where the UE transmits an SCG failure information message to the MN. Otherwise, the flow proceeds to block 1714, where the UE initiates an RRC connection reestablishment procedure with the MN.

FIG. 18 is a flow diagram of a method 1800 that a UE (e.g., the UE 102) can implement in response to determining that the UE is unable to apply an MN or an SN configuration in an RRC resume message. At some time before performing the method 1800, the UE communicates in DC with an MN and an SN (e.g., MN 104 and SN 106) (e.g., event 302A, 302B, 402A, 402B, 502A, or 502B, or similar events within procedures 351C, 351D, 351E, 451C, 451D, 451E, 551C, 551D, or 551E). At block 1802, the UE suspends MR-DC (e.g., event 316A, 316B, 416A, 416B, 516A, or 516B, or similar events within procedures 351C, 351D, 351E, 451C, 451D, 451E, 551C, 551D, or 551E). At a later time, the UE at block 1804 transmits an RRC resume request message to the MN (e.g., event 322A-E, 422A-E, or 522A-E), and receives an RRC resume message at block 1806 in response (e.g., event 334A, 335D, 534A, or 535D, or similar events within procedures 360B, 360C, 361E, 460A, 460B, 460C, 461D, 461E, 560B, 560C, or 561E).

At block 1810, the UE determines whether the UE is unable to comply with all or a portion of an MN configuration in the RRC resume message. If the UE cannot comply with all or a portion of the MN configuration, then the flow proceeds to block 1812, where the UE transitions to an idle state without a suspended radio connection. If the UE can comply with the MN configuration, then the flow proceeds to block 1814, where the UE determines whether the UE can comply with all or a portion of an SN configuration in the RRC resume message. If the UE cannot comply with all or a portion of the SN configuration, then the flow proceeds to block 1816, where the UE transmits an SCG failure information message to the MN. If the UE can comply with the SN configuration, then the flow proceeds to block 1818, where the UE resumes MR-DC in accordance with the MN and the SN configurations included in the RRC resume message.

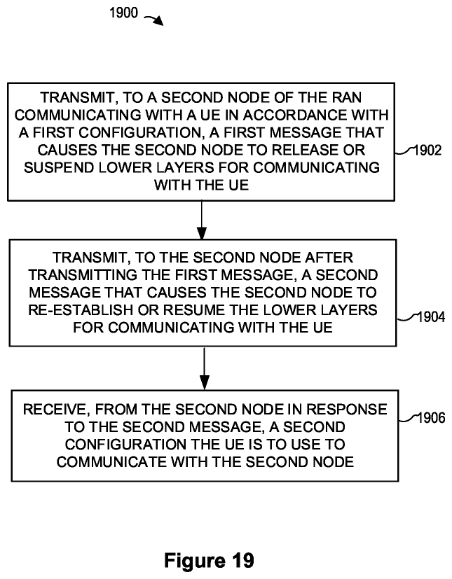

FIG. 19 is a flow diagram of a method 1900 of facilitating resumption of DC for a UE (e.g., the UE 102), which can be implemented by a first node (e.g., the MN 104 or the CU 172) of a RAN (e.g., the RAN 105). At block 1902, the first node transmits, to a second node (e.g., the SN 106, the CU 172 of the SN 106, or the S-DU 174B of the base station 106) of the RAN that communicates with the UE in accordance with a first configuration, a first message that causes the second node to release or suspend lower layers for communicating with the UE (e.g., event 308A, 309B, 408A, 409B, 572A, or 571B, or similar events within procedures 351C, 351D, 351E, 451C, 451D, 451E, 551C, 551D, or 551E). At block 1904, the first node transmits, to the second node after transmitting the first message, a second message that causes the second node to re-establish or resume the lower layers for communicating with the UE (e.g., event 328A, 327B, 329C, 329D, 329E, 428A, 427B, 429C, 429D, 429E, 582A, 581B, 581C, 586D, or 586E). At block 1906, the first node receives, from the second node and in response to the second message, a second configuration the UE is to use to communicate with the second node (e.g., event 332A, 332B, 333C, 331D, 331E, 432A, 432B, 433C, 431D, 431E, 584A, 583B, 583C, 588D, or 588E).

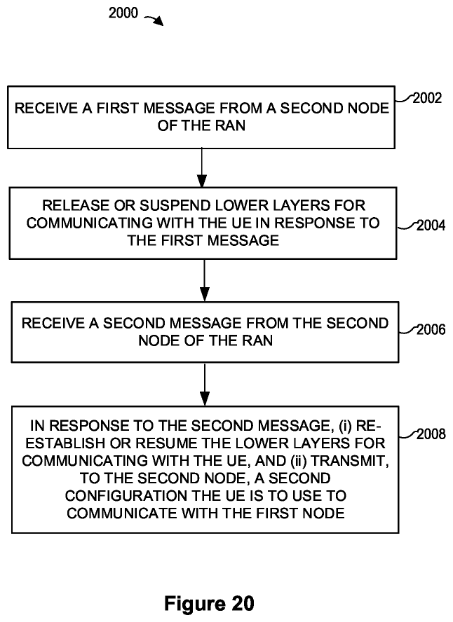

FIG. 20 is a flow diagram of a method 2000 of facilitating resumption of DC for a UE (e.g., the UE 102), which can be implemented by a first node (e.g., the SN 106, the CU 172 of the SN 106, or the S-DU 174B of the base station 106) of a RAN (e.g., the RAN 105). At block 2002, the first node receives a first message from a second node (e.g., the MN 104 or the CU 172 of the base station 106) of the RAN (e.g., event 308A, 309B, 408A, 409B, 572A, or 571B, or similar events within procedures 351C, 351D, 351E, 451C, 451D, 451E, 551C, 551D, or 551E). At block 2004, the first node releases or suspends, by processing hardware, lower layers for communicating with the UE in response to the first message (e.g., event 310A, 311B, 410A, 411B, 510A, or 511B, or similar events within procedures 351C, 351D, 351E, 451C, 451D, 451E, 551C, 551D, or 551E).

At block 2006, the first node receives a second message from the second node (e.g., event 328A, 327B, 329C, 329D, 329E, 428A, 427B, 429C, 429D, 429E, 582A, 581B, 581C, 586D, or 586E). At block 2008, in response to the second message, the first node (i) re-establishes or resumes, by the processing hardware, the lower layers for communicating with the UE, and (ii) transmits, to the second node, a second configuration the UE is to use to communicate with the first node (e.g., event 332A, 332B, 333C, 331D, 331E, 432A, 432B, 433C, 431D, 431E, 584A, 583B, 583C, 588D, or 588E).

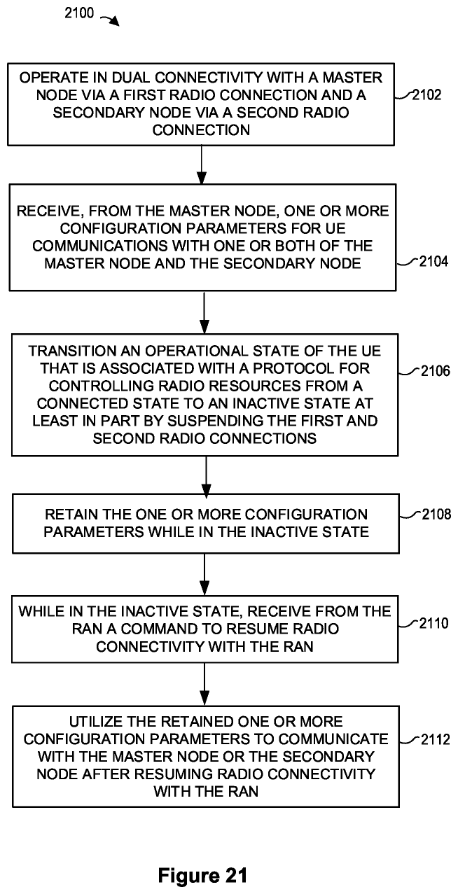

FIG. 21 is a flow diagram of a method 2100 for resuming DC with a RAN, which can be implemented by a UE (e.g., the UE 102). At block 2102, the UE operates in DC with an MN via a first radio connection and an SN via a second radio connection (e.g., block 1602). At block 2104, the UE receives, from the MN, one or more configuration parameters for UE communications with one or both of the master node and the secondary node (e.g., power and/or timing requirements) (e.g., block 1604). At block 2106, the UE transitions, by processing hardware, an operational state of the UE that is associated with a protocol for controlling radio resources from a connected state to an inactive state at least in part by suspending the first and second radio connections (e.g., block 1608).

At block 2108, the UE retains the one or more configuration parameters while in the inactive state (e.g., block 1616). In addition, at block 2110, while the UE is in the inactive state, the UE receives from the RAN a command to resume radio connectivity with the RAN (e.g., block 1612). At block 2112, the UE utilizes the retained one or more configuration parameters to communicate with the master node or the secondary node after resuming radio connectivity with the RAN.

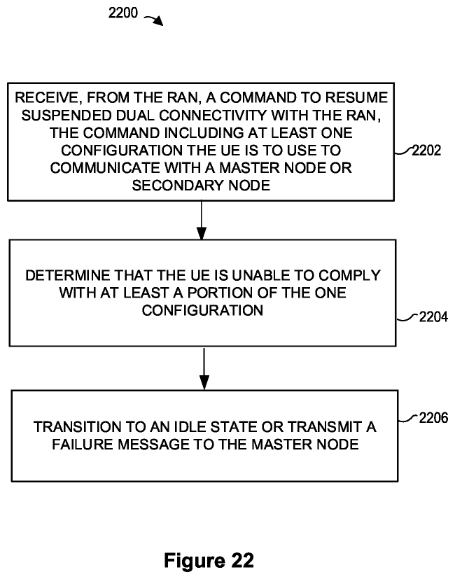

FIG. 22 is a flow diagram of a method 2200 for resuming DC with a RAN, which can be implemented by a UE (e.g., the UE 102). At block 2202, the UE receives, from the RAN (e.g., from a base station 104 or 106 of the RAN 105), a command to resume suspended DC with the RAN (e.g., block 1702 or block 1806). The command includes at least one configuration the UE is to use to communicate with an MN or an SN of the RAN. At block 2204, the UE determines, by processing hardware, that the UE is unable to comply with at least a portion of the at least one configuration (e.g., block 1704, 1810, or 1814). At block 2206, the UE, in response to the determination at block 2204, transitions to an idle state (e.g., block 1708 or block 1812) or transmits a failure message to the master node (e.g., block 1816).

The following list of examples reflects a variety of the embodiments explicitly contemplated by the present disclosure.

Example 1. A method, in a first node of a radio access network (RAN), of facilitating resumption of dual connectivity for a user equipment (UE), the method comprising: transmitting, to a second node of the RAN communicating with the UE in accordance with a first configuration, a first message that causes the second node to release or suspend lower layers for communicating with the UE; transmitting, to the second node after transmitting the first message, a second message that causes the second node to re-establish or resume the lower layers for communicating with the UE; and receiving, from the second node in response to the second message, a second configuration the UE is to use to communicate with the second node.

Example 2. The method of example 1, wherein the second message indicates that the second node is to resume the lower layers.

Example 3. The method of example 2, further comprising: determining, by processing hardware of the first node, whether the UE releases the first configuration before resuming radio connectivity; and generating, by the processing hardware, the second message, wherein generating the second message comprises including or not including a request to provide a full configuration in the second message based on whether the UE releases the first configuration before resuming radio connectivity.

Example 4. The method of example 3, wherein: determining whether the UE releases the first configuration before resuming radio connectivity includes determining that the UE releases the first configuration; generating the second message comprises including a request to provide a full configuration in the second message; and receiving the second configuration includes receiving a full configuration in response to the request to provide a full configuration.

Example 5. The method of example 3, wherein: determining whether the UE releases the first configuration before resuming radio connectivity includes determining that the UE does not release the first configuration; generating the second message comprises not including a request to provide a full configuration in the second message; and receiving the second configuration includes receiving a delta configuration.

Example 6. The method of example 2, wherein receiving the second configuration includes receiving a third message that includes the second configuration and an indication that the second configuration is a full configuration.

Example 7. The method of example 2, wherein receiving the second configuration includes receiving a delta configuration.

Example 8. The method of any one of examples 2-7, wherein: transmitting the first message includes transmitting a first request to modify a UE context; transmitting the second message includes transmitting a second request to modify a UE context; the first node is a central unit of a base station; the second node is a first distributed unit of the base station; the central unit and the first distributed unit collectively operate as a secondary node supporting dual connectivity with the UE; the central unit and a second distributed unit of the base station collectively operate as a master node supporting dual connectivity with the UE; and the second configuration is a configuration the UE is to use to communicate with the first distributed unit.

Example 9. The method of any one of examples 1-7, wherein: transmitting the first message includes transmitting a first secondary node modification request; and transmitting the second message includes transmitting a second secondary node modification request.

Example 10. The method of example 9, wherein the first node is a first base station operating as a master node supporting dual connectivity with the UE, and the second node is a second base station operating as a secondary node supporting dual connectivity with the UE.

Example 11. The method of example 10, wherein: transmitting the second message includes transmitting the second message to a central unit of the second base station, the second base station also including a distributed unit; receiving the second configuration includes receiving the second configuration from the central unit; and the second configuration is a configuration the UE is to use to communicate with the distributed unit.

Example 12. The method of example 1, wherein: the second message indicates that the second node is to re-establish the lower layers; and receiving the second configuration includes receiving a full configuration.

Example 13. The method of any one of examples 1 or 12, wherein: transmitting the first message includes transmitting a command to release a UE context; transmitting the second message includes transmitting a request to setup a UE context that causes the second node to re-establish the lower layers for communicating with the UE; the first node is a central unit of a base station; the second node is a first distributed unit of the base station; the central unit and the first distributed unit collectively operate as a secondary node supporting dual connectivity with the UE; the central unit and a second distributed unit of the base station collectively operate as a master node supporting dual connectivity with the UE; and the second configuration is a full configuration the UE is to use to communicate with the first distributed unit.

Example 14. The method of example 1, further comprising: receiving a request to resume radio connectivity from the UE; and transmitting the second configuration to the UE in response to the request to resume radio connectivity.

Example 15. The method of example 14, wherein the second configuration includes one or more parameters indicating one or both of power and timing requirements for UE uplink transmissions to one or both of the first node and the second node.

Example 16. A method, in a first node of a radio access network (RAN), of facilitating resumption of dual connectivity for a user equipment (UE), wherein the first node previously communicated with the UE in accordance with a first configuration, the method comprising: receiving a first message from a second node of the RAN; releasing or suspending, by processing hardware of the first node, lower layers for communicating with the UE in response to the first message; receiving a second message from the second node; and in response to the second message, re-establishing or resuming, by the processing hardware, the lower layers for communicating with the UE, and transmitting, to the second node, a second configuration the UE is to use to communicate with the first node.

Example 17. The method of example 16, wherein re-establishing or resuming the lower layers for communicating with the UE includes resuming the lower layers.

Example 18. The method of example 17, wherein: the second message includes a request to provide a full configuration; and transmitting the second configuration includes transmitting a full configuration in response to the request to provide a full configuration.

Example 19. The method of example 17, wherein transmitting the second configuration includes transmitting a delta configuration.

Example 20. The method of example 17, further comprising: determining, by the processing hardware, whether the UE releases the first configuration before resuming radio connectivity, wherein transmitting the second configuration includes transmitting a full configuration or a delta configuration based on whether the UE releases the first configuration before resuming radio connectivity.

Example 21. The method of example 20, wherein: determining whether the UE releases the first configuration before resuming radio connectivity includes determining that the UE releases the first configuration; and transmitting the second configuration includes transmitting a third message including the full configuration, and includes an indication that the second configuration is a full configuration, in response to determining that the UE releases the first configuration.

Example 22. The method of example 20, wherein: determining whether the UE releases the first configuration before resuming radio connectivity includes determining that the UE does not release the first configuration; and transmitting the second configuration includes transmitting the delta configuration in response to determining that the UE does not release the first configuration.

Example 23. The method of any one of examples 17-22, wherein: receiving the first message includes receiving a first request to modify a UE context; receiving the second message includes receiving a second request to modify a UE context; the second node is a central unit of a base station; the first node is a first distributed unit of the base station; the central unit and the first distributed unit collectively operate as a secondary node supporting dual connectivity with the UE; the central unit and a second distributed unit of the base station collectively operate as a master node supporting dual connectivity with the UE; and the second configuration is a configuration the UE is to use to communicate with the first distributed unit.

Example 24. The method of any one of examples 16-22, wherein: receiving the first message includes receiving a first secondary node modification request; and receiving the second message includes receiving a second secondary node modification request.

Example 25. The method of example 24, wherein: the first message includes an indication to release the lower layers; and the method further comprises retaining one or more interface identifiers for the UE for use when dual connectivity with the UE is re-established or resumed.

Example 26. The method of example 24, wherein: the first node is a first base station operating as a secondary node supporting dual connectivity with the UE; and the second node is a second base station operating as a master node supporting dual connectivity.

Example 27. The method of example 16, wherein: re-establishing or resuming the lower layers for communicating with the UE includes re-establishing the lower layers; and transmitting the second configuration includes transmitting a full configuration.

Example 28. The method of example 27, wherein: receiving the first message includes receiving a command to release a UE context; receiving the second message includes receiving a request to setup a UE context; the second node is a central unit of a base station; the first node is a first distributed unit of the base station; the central unit and the first distributed unit collectively operate as a secondary node supporting dual connectivity with the UE; the central unit and a second distributed unit of the base station collectively operate as a master node supporting dual connectivity with the UE; the second configuration is a full configuration the UE is to use to communicate with the distributed unit; and releasing or suspending the lower layers for communicating with the UE includes releasing the first configuration in accordance with the first message.

Example 29. The method of example 16, wherein: the first node includes a central unit and a distributed unit that collectively operate as a secondary node supporting dual connectivity with the UE; receiving the first message includes receiving a first secondary node modification request at the central unit; receiving the second message includes receiving a second secondary node modification request at the central unit; transmitting the second configuration includes transmitting the second configuration to the second node from the central unit; and the second configuration is a configuration the UE is to use for communicating with the distributed unit.

Example 30. The method of example 29, wherein releasing or suspending the lower layers for communicating with the UE includes releasing the lower layers, and wherein the method further comprises: transmitting, from the central unit to the distributed unit in response to the first secondary node modification request, a command to release a UE context.

Example 31. The method of example 30, wherein re-establishing or resuming the lower layers for communicating with the UE includes re-establishing the lower layers, and wherein the method further comprises: transmitting, from the central unit to the distributed unit in response to the second secondary node modification request, a request to setup a context of the UE; and receiving, at the central unit from the distributed unit in response to the request to setup a context of the UE, a full configuration the UE is to use to communicate with the distributed unit.

Example 32. The method of example 29, wherein releasing or suspending the lower layers for communicating with the UE includes suspending the lower layers, and wherein the method further comprises: transmitting, from the central unit to the distributed unit in response to the first secondary node modification request, a first request to modify a context of the UE, the first request to modify a context of the UE including an indication to suspend the lower layers.

Example 33. The method of example 32, wherein re-establishing or resuming the lower layers for communicating with the UE includes resuming the lower layers, and wherein the method further comprises: transmitting, from the central unit to the distributed unit in response to the second secondary node modification request, a second request to modify a context of the UE.

Example 34. The method of example 33, wherein: the second secondary node modification request includes a request to provide a full configuration; transmitting the second request to modify a context of the UE includes transmitting a request to provide a full configuration; and the method further comprises receiving, at the central unit from the distributed unit, the full configuration in response to the second request.

Example 35. The method of example 33, further comprising: determining, at the central unit, whether the UE releases the first configuration before resuming radio connectivity; and requesting or not requesting, by the central unit, a full configuration from the distributed unit based on whether the UE releases the first configuration before resuming radio connectivity.

Example 36. The method of example 35, wherein: determining whether the UE releases the first configuration before resuming radio connectivity includes determining that the UE releases the first configuration; transmitting the second request to modify a context of the UE includes transmitting a request to provide a full configuration; the method further comprises receiving, at the central unit from the distributed unit in response to the second request to modify a context of the UE, a full configuration; and the second configuration is the full configuration.

Example 37. The method of example 35, wherein: determining whether the UE releases the first configuration before resuming radio connectivity includes determining that the UE does not release the first configuration; transmitting the second request to modify a context of the UE includes transmitting a request to resume the lower layers for communicating with the UE without transmitting a request to provide a full configuration; the method further comprises receiving, at the central unit from the distributed unit in response to the second request to modify a context of the UE, a delta configuration; and the second configuration is the delta configuration.

Example 38. The method of example 33, wherein: transmitting the second request to modify a context of the UE includes transmitting an indication to resume the lower layers for the UE; the method further comprises receiving, at the central unit from the distributed unit, a delta configuration; and the second configuration is the delta configuration.

Example 39. A network node of a radio access network (RAN) including processing hardware and configured to implement a method according to any one of examples 1-38.

Example 40. A method, in a user equipment (UE) for resuming dual connectivity in a radio access network (RAN), the method comprising: operating in dual connectivity with a master node via a first radio connection and a secondary node via a second radio connection; receiving, from the master node, one or more configuration parameters for UE communications with one or both of the master node and the secondary node; transitioning, by processing hardware of the UE, an operational state of the UE that is associated with a protocol for controlling radio resources from a connected state to an inactive state at least in part by suspending the first and second radio connections; retaining the one or more configuration parameters while in the inactive state; while in the inactive state, receiving from the RAN a command to resume radio connectivity with the RAN; and utilizing the retained one or more configuration parameters to communicate with the master node or the secondary node after resuming radio connectivity with the RAN.

Example 41. The method of example 40, wherein at least one of the one or more configuration parameters indicates a requirement for UE uplink transmissions to one or both of the master node and the secondary node.

Example 42. The method of example 41, wherein at least one of the one or more configuration parameters indicates a maximum power limit for the UE uplink transmissions.

Example 43. The method of example 41, wherein at least one of the one or more configuration parameters indicates a timing requirement for the UE uplink transmissions.

Example 44. The method of example 40, wherein: receiving the command to resume radio connectivity includes receiving a configuration that the UE is to use to communicate with the master node or the secondary node; and communicating with the master node or the secondary node after resuming radio connectivity includes communicating with the master node or the secondary node in accordance with the configuration.

Example 45. A method in a user equipment (UE) for resuming dual connectivity in a radio access network (RAN), the method comprising: receiving, from the RAN, a command to resume suspended dual connectivity with the RAN, the command including at least one configuration the UE is to use to communicate with a master node or a secondary node; determining, by processing hardware, that the UE is unable to comply with at least a portion of the at least one configuration; and in response to the determining, transitioning to an idle state or transmitting a failure message to the master node.

Example 46. The method of example 45, wherein: receiving the at least one configuration includes receiving a configuration the UE is to use to communicate with the secondary node; determining that the UE is unable to comply with at least the portion of the at least one configuration includes determining that the UE is unable to comply with at least a portion of the configuration the UE is to use to communicate with the secondary node; and transitioning to an idle state or transmitting a failure message to the master node includes transitioning to an idle state.

Example 47. The method of example 45, wherein: receiving the at least one configuration includes receiving a first configuration the UE is to use to communicate with the master node and a second configuration the UE is to use to communicate with the secondary node; determining that the UE is unable to comply with at least a portion of the at least one configuration includes determining that the UE is unable to comply with at least a portion of the second configuration; the method further comprises determining that the UE is able to comply with at least a portion of the first configuration; and transitioning to an idle state or transmitting a failure message to the master node includes transmitting a failure message to the master node.

Example 48. The method of example 47, wherein the failure message indicates a secondary cell group failure.

Example 49. A user equipment (UE) including processing hardware and configured to implement a method according to any one of examples 40-48.

### Additional Considerations

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can include dedicated circuitry or logic that is permanently configured (e.g., as a special-purpose processor, such as a field programmable gate array (FPGA) or an application-specific integrated circuit (ASIC), a digital signal processor (DSP)) to perform certain operations. A hardware module may also include programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for resuming MR-DC between a UE and a RAN through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method, in a node of a radio access network (RAN), of facilitating resumption of a dual connectivity for a user equipment (UE), the method comprising:
receiving, from the UE, a request to resume a radio connectivity with the RAN;
determining whether the UE is to resume a dual connection with the RAN;
generating a message to instruct the UE to resume the radio connectivity with the RAN, the generating including:
in response to a result of the determining being that the UE is to resume the dual connection, including in the message an indication of a maximum power limit for UE uplink transmissions; and
in response to the result of the determining being that the UE is not to resume the dual connection, excluding the indication from the message; and
transmitting the message to the UE.

2. The method of claim 1, wherein the message is a radio resource control (RRC) resume message.

3. The method of claim 1, wherein the indication of the maximum power limit is a p-MaxEUTRA information element (IE).

4. The method of claim 1, wherein the indication of the maximum power limit is a p-MaxUE-FR1 information element (IE).

5. The method of claim 1, wherein the determining includes:
determining whether the dual connection is a multi-radio dual connection.

6. The method of claim 1, wherein the node is a first node, the method further comprising:
determining that the UE is to resume the dual connection;
prior to receiving the request from the UE, transmitting, to a second node of the RAN communicating with the UE in accordance with a first configuration, a first message that causes the second node to release or suspend lower layers for communicating with the UE;
determining, after receiving the request from the UE, that the UE releases the first configuration before resuming the radio connectivity;
generating and transmitting, to the second node, a second message that causes the second node to resume the lower layers for communicating with the UE, the second message including a request to provide a full configuration replacing the first configuration;
receiving, from the second node in response to the second message, the full configuration the UE is to use to communicate with the second node; and
including, in the message to the UE, the full configuration.

7. (canceled)

8. The method of claim 1, wherein the node is a first node, the method further comprising:
determining that the UE is to resume the dual connection;
prior to receiving the request from the UE, transmitting, to a second node of the RAN communicating with the UE in accordance with a first configuration, a first message that causes the second node to release or suspend lower layers for communicating with the UE;
determining that the UE does not release the first configuration;
generating and transmitting, to the second node, a second message including a request to provide a delta configuration specifying changes from the first configuration; and
receiving, from the second node in response to the second message, the delta configuration; and
including, in the message to the UE, the delta configuration.

9. The method of claim 1, wherein the node determines to resume the dual connection with the UE, the method further comprising:
after transmitting the message, operating as a master node to support the dual connection with the UE.

10. A node of a radio access network (RAN), the node including communication hardware configured to perform a method comprising:
receiving, from a user equipment (UE), a request to resume a radio connectivity with the RAN;
determining whether the UE is to resume a dual connection with the RAN;
generating a message to instruct the UE to resume the radio connectivity with the RAN, the generating including:
in response to a result of the determining being that the UE is to resume the dual connection, including in the message an indication of a maximum power limit for UE uplink transmissions; and
in response to the result of the determining being that the UE is not to resume the dual connection, excluding the indication from the message; and
transmitting the message to the UE.

11. A method, in a user equipment (UE) for resuming a dual connectivity in a radio access network (RAN), the method comprising:
operating in the dual connectivity with a master node via a first radio connection and a secondary node via a second radio connection;
receiving, from the master node, an indication of a time division multiplexing pattern that enables UE communications with one or both of the master node and the secondary node;
transitioning an operational state of the UE that is associated with a protocol for controlling radio resources from a connected state to an inactive state at least in part by suspending the first and second radio connections;
while in the inactive state, receiving, from the RAN, a command to resume a radio connectivity with the RAN; and
if the command configures the UE for single connectivity, releasing the time division multiplexing pattern.

12. The method of claim 11, wherein the indication of the time division multiplexing pattern is a tdm-PatternConfig information element (IE).

13. The method of claim 11, wherein:
receiving the command to resume the radio connectivity includes receiving a configuration that the UE is to use to communicate with the master node and/or the secondary node; and
the method further comprises communicating with the master node and/or the secondary node in accordance with the configuration.

14. (canceled)

15. The method of claim 11, wherein the command is a radio resource control (RRC) resume message.

16. A user equipment (UE) including communication hardware configured to perform a method comprising:
operating in the dual connectivity with a master node via a first radio connection and a secondary node via a second radio connection;
receiving, from the master node, an indication of a time division multiplexing pattern that enables UE communications with one or both of the master node and the secondary node;
transitioning an operational state of the UE that is associated with a protocol for controlling radio resources from a connected state to an inactive state at least in part by suspending the first and second radio connections;
while in the inactive state, receiving, from a radio access network (RAN), a command to resume a radio connectivity with the RAN; and
if the command configures the UE for single connectivity, releasing the time division multiplexing pattern.

17. The UE of claim 16, wherein the indication of the time division multiplexing pattern is a tdm-PatternConfig information element (IE).

18. The UE of claim 16, wherein:
the command to resume the radio connectivity includes a configuration that the UE is to use to communicate with the master node or the secondary node; and
the communication hardware is further configured to communicate with the master node or the secondary node in accordance with the configuration.

19. The UE of claim 16, wherein the command is a radio resource control (RRC) resume message.

20. The node of claim 10, wherein the indication of the maximum power limit is a p-MaxEUTRA information element (IE) or a p-MaxUE-FR1 IE.

21. The node of claim 10, wherein the node is a first node, and wherein the method further comprises:
determining that the UE is to resume the dual connection;
prior to receiving the request from the UE, transmitting, to a second node of the RAN communicating with the UE in accordance with a first configuration, a first message that causes the second node to release or suspend lower layers for communicating with the UE;
determining, after receiving the request from the UE, that the UE releases the first configuration before resuming the radio connectivity;
generating and transmitting, to the second node, a second message that causes the second node to resume the lower layers for communicating with the UE, the second message including a request to provide a full configuration replacing the first configuration;
receiving, from the second node in response to the second message, the full configuration the UE is to use to communicate with the second node; and
including, in the message to the UE, the full configuration.

22. The node of claim 10, wherein the node is a first node, and wherein the method further comprises:
determining that the UE is to resume the dual connection;
prior to receiving the request from the UE, transmitting, to a second node of the RAN communicating with the UE in accordance with a first configuration, a first message that causes the second node to release or suspend lower layers for communicating with the UE;
determining that the UE does not release the first configuration;
generating and transmitting, to the second node, a second message including a request to provide a delta configuration specifying changes from the first configuration; and
receiving, from the second node in response to the second message, the delta configuration; and
including, in the message to the UE, the delta configuration.
